(19) United States
(12) Patent Application Publication
(10) Pub. No.: US 2002/0044302 A1
(43) Pub. Date: Apr. 18, 2002

(54) Method and apparatus for facsimile communications capable of using functions of other facsimile terminals

(76) Inventor: Tetsuya Kagawa, Kanagawa-ken (JP)

Correspondence Address: Ivan S. Kavrukov, Cooper & Dunham LLP, 1185 Avenue of the Americas, New York, NY, 10036, US

(21) Appl. No.: 09/881,402

(22) Filed: Jun. 14, 2001

(30) Foreign Application Priority Data
Jun. 14, 2000 (JP) 2000-178911
Mar. 23, 2001 (JP) 2001-85353

(51) Int. Cl. H04N 1/00

(52) U.S. Cl. 358/408

(57) ABSTRACT

A communications apparatus includes a communications mechanism, a registering mechanism, a notifying mechanism, and a controlling mechanism. The communications mechanism performs communications with a sending communications machine and a transfer communications machine. The registering mechanism registers an address and a communications capability of the transfer communications machine. The notifying mechanism notifies of the communications capability of the transfer communications machine registered in the registering mechanism. The controlling mechanism instructs the notifying mechanism to notify the sending communications machine of the communications capability at a beginning of communications and to instruct the communications mechanism to transfer image information received from the sending communications machine to the transfer communications machine using the address stored in the registering mechanism.

### BACKGROUND

1. Field

The present application relates to a method and apparatus for facsimile communications, and more particularly to a method and apparatus for data communications capable of using functions of other facsimile terminals such as a color printing capability.

2. Description of Background Art

A color facsimile apparatus capable of receiving and reproducing a color image has been developed but can be too expensive for common use.

When a color image is transmitted, it is normally encoded in a JPEG or JBIG format. These formats are capable of transmitting not only a color image but also a mono-color gray-scale image. For this reason, when a facsimile machine returns a notification signal with respect to a facsimile receiving capability, including a color image receiving capability, the facsimile machine receives in some cases a mono-color gray-scale image. However, decoding of a mono-color gray-scale image in JPEG or JBIG requires installation of specific hardware and/or software which is an additional cost.

### SUMMARY

The present application describes a novel communications apparatus. In one example, a novel communications apparatus includes a communications mechanism, a registering mechanism, a notifying mechanism, and a controlling mechanism. The communications mechanism is configured to perform communications with a plurality of communications machines including a sending communications machine and a transfer communications machine. The registering mechanism is configured to register an address and a communications capability of the transfer communications machine. The notifying mechanism is configured to notify of the communications capability of the transfer communications machine registered in the registering mechanism. The controlling mechanism is configured to instruct the notifying mechanism to notify the sending communications machine of the communications capability at a beginning of communications and to instruct the communications mechanism to transfer image information received from the sending communications machine to the transfer communications machine using the address stored in the registering mechanism.

The present application further describes another novel communications terminal apparatus. In one example, a novel communications terminal apparatus includes a communications mechanism, a registering mechanism, a memory, a notifying mechanism, and a controlling mechanism. The communications mechanism is configured to perform communications with a plurality of communications machines including a sending communications machine and a transfer communications machine. The registering mechanism is configured to register an address and a communications capability of the transfer communications machine. The memory stores a set of image parameters. The notifying mechanism is configured to notify of an enhancement communications capability of the apparatus in accordance with the communications capability of the transfer communications machine. The controlling mechanism is configured to instruct the notifying mechanism to notify the sending communications machine of the enhancement communications capability at a beginning of communications and to instruct the communications mechanism to transfer image information received from the sending communications machine to the transfer communications machine using the address and the set of image parameters stored in memory.

The image information may include color or mono-color gray-scale data.

The above-described communications apparatus may further include an enabling mechanism for enabling a color image receiving function when the address and the communications capability of the transfer communications machine are registered in the registering mechanism.

The controlling mechanism may instruct the communications mechanism to communicate with the transfer communications machine to obtain the communications capability of the transfer communications machine when the communications capability of the transfer communications machine are registered in the registering mechanism.

The above-described communications apparatus may further include another communications mechanism configured to perform communications with a plurality of communications machines including a sending communications machine and a transfer communications machine. In this case, the apparatus separately uses the communications mechanisms for receiving and transferring. Further, in this case, the controlling mechanism changes communications protocols for a transferring operation and accordingly converts the image parameters stored in the memory.

The controlling mechanism may start to transfer the image information received from the sending communications machine to the transfer communications machine before a completion of receiving the image information from the sending communications machine.

The controlling mechanism may obtain a latest communications capability through the communications mechanism when transferring the image information and updates the registration mechanism with the latest communications capability.

The controlling mechanism may obtain a latest communications capability through the communications mechanism at intervals of a predetermined time period and updates the registration mechanism with the latest communications capability.

The controlling mechanism may detect at the beginning of the communications that the image information is sent and conducts an call initiation to the transfer communications machine when detecting that the image information is sent.

The controlling mechanism may detect that the transfer communications machine is busy and then stops receiving the image information from the sending communications machine.

The controlling mechanism may transfer the image information to another registered transfer communications machine upon a detection of an event indicating that the transfer communications machine is busy.

The controlling mechanism may perform a retry call to the transfer communications machine upon a detection of an event indicating that the transfer communications machine is busy.

The controlling mechanism may perform a retry call at intervals of a predetermined time period to the transfer communications machine upon a detection of an event indicating that the transfer communications machine is busy.

The controlling mechanism may transfer the image information in page units.

The controlling mechanism may transfer the image information using a type of communications same as that used to receive the image information with the communications mechanism.

The controlling mechanism may transfer the image information through E-mail to the transfer communications machine.

The controlling mechanism may detect that the transfer communications machine is incapable of receiving the image information and then stops receiving the image information from the sending communications machine.

The controlling mechanism may determine whether the latest communications capability is sufficient to receive the image information and stops receiving the image information from the sending communications machine when the latest communications capability is determined as not sufficient to receive the image information.

The controlling mechanism may add a literal identification of the image information to the E-mail.

The controlling mechanism may transfer the image information with a predetermined identification code so that the transfer communications machine reproduces an output of the image information into a predetermined recording sheet tray corresponding to the predetermined identification code.

The controlling mechanism may determine whether an own communications capability can accept the image information and transfers the image information to the transfer communications machine when the own communications capability of the apparatus cannot accept the image information.

The present application further describes a novel method of transferring image information. In one example, a novel method of transferring image information includes the steps of registering, notifying, receiving, and transferring. The registering step registers an address and a communications capability of a transfer communications machine. The notifying step notifies a sending communications machine of the communications capability of the transfer communications machine at a beginning of communications. The receiving step receives image information from the sending communications machine. The transferring step transfers the image information received from the sending communications machine to the transfer communications machine using the address of the transfer communications machine.

The present application further describes a method of transferring image information. In one example, a novel method includes the steps of registering, storing, notifying, receiving, and transferring. The registering step registers an address and a communications capability of a transfer communications machine. The storing step stores a set of image parameters. The notifying step notifies of an enhancement communications capability in accordance with the communications capability of the transfer communications machine at a beginning of communications. The receiving step receives image information from a sending communications machine. The transferring step transfers the image information received from the sending communications machine to the transfer communications machine using the address and the set of image parameters stored in the storing step.

The image information may include color or mono-color gray-scale data.

The above-described method may further include a step of enabling for enabling a color image receiving function when the registering step registers the address and the communications capability of the transfer communications machine.

The above-described method may further include a step of communicating for communicating with the transfer communications machine to obtain the communications capability of the transfer communications machine when the registering step registers the communications capability of the transfer communications machine.

The transferring step may use a communications line and communications protocols different from those used for the receiving step with different image parameters converted from the image parameters stored in the storing step.

The transferring step may start to transfer the image information before a completion of receiving the image information from the sending communications machine.

The transferring step may obtain a latest communications capability from the transfer communications machine when transferring the image information and updates the latest communications capability registered in the registering step.

The transferring step may obtain a latest communications capability from the transfer communications machine at intervals of a predetermined time period and updates the latest communications capability registered in the registering step.

The above-described method may further include a step of detecting for detecting at the beginning of the communications that the image information is sent. In this case, the transferring step sends a call initiation to the transfer communications machine when the detecting step detects that the image information is sent.

The above-described method may further include a detecting step for detecting that the transfer communications machine is busy. In this case, the receiving step stops receiving when the detecting step detects that the transfer communications machine is busy.

The transferring step may transfer the image information to another registered transfer communications machine upon a detection of an event that the transfer communications machine is busy.

The transferring step may perform a retry call to the transfer communications machine upon a detection of an event that the transfer communications machine is busy.

The transferring step may perform a retry call at intervals of a predetermined time period to the transfer communications machine upon a detection of an event that the transfer communications machine is busy.

The transferring step may transfer the image information in page units.

The transferring step may transfer the image information using a type of communications same as that used by the receiving step.

The transferring step may transfer the image information through E-mail to the transfer communications machine.

The above-described method may further include a detecting step for detecting that the transfer communications machine is incapable of receiving the image information. In this case, the receiving step stops receiving when the detecting step detects that the transfer communications machine is incapable of receiving the image information.

The above-described method may further include a determining step for determining whether the latest communications capability is sufficient to receive the image information. In this case, the receiving step stops receiving when the determining step determines the latest communications capability is not sufficient to receive the image information.

The above-described method may further include an adding step for adding a literal identification of the image information to the E-mail.

The transferring step may transfer the image information with a predetermined identification code so that the transfer communications machine reproduces an output of the image information into a predetermined recording sheet tray corresponding to the predetermined identification code.

The above-described method may further include a determining step for determining whether an own communications capability can accept the image information. In this case, the transferring step transfers the image information to the transfer communications machine when the determining step determines that the own communications capability of the apparatus cannot accept the image information.

### BRIEF DESCRIPTION OF THE DRAWINGS

A more complete appreciation of the present application and many of the attendant advantages thereof will be readily obtained as the same becomes better understood by reference to the following detailed description when considered in connection with the accompanying drawings, wherein:

FIG. 1 is an illustration of a facsimile system according to a preferred embodiment;

FIG. 2 is a block diagram of a facsimile apparatus included in the facsimile system of FIG. 1;

FIG. 3 is an exemplary table of color image parameters stored in an image parameter memory of the facsimile apparatus of FIG. 2;

FIG. 4 is a flowchart for explaining an exemplary procedure of registration of a color facsimile machine to which a received color facsimile is transferred from the facsimile apparatus of FIG. 2;

FIG. 5 is a flowchart for explaining an exemplary procedure of a facsimile receiving and transmission operation performed by the facsimile apparatus of FIG. 2;

FIGS. 6 and 7 are flowcharts of modified procedures of the color facsimile machine registration performed by the facsimile apparatus of FIG. 2;

FIG. 8 is a flowchart for explaining another procedure of the facsimile receiving and transmission operation performed by the facsimile apparatus of FIG. 2;

FIG. 9 is a block diagram of another facsimile apparatus according to a preferred embodiment;

FIG. 10 is an exemplary table of color image parameters stored in an image parameter memory of the facsimile apparatus of FIG. 9;

FIG. 11 is a flowchart for explaining an exemplary procedure of registration of a color facsimile machine to which a received color facsimile is transferred from the facsimile apparatus of FIG. 9;

FIGS. 12 and 13A-13B are flowcharts for respectively explaining exemplary procedures of a facsimile receiving and transmission operation performed by the facsimile apparatus of FIG. 9;

FIG. 14 is a flowchart for explaining a modified procedure of the color facsimile machine registration performed by the facsimile apparatus of FIG. 9;

FIG. 15 is an illustration for explaining a time when the facsimile apparatus of FIG. 9 determines whether the received facsimile includes color or mono-color gray-scale data;

FIGS. 16 and 17 are flowcharts for respectively explaining modified procedures of the facsimile receiving and transmission operation performed by the facsimile apparatus of FIG. 9;

FIG. 18 is another table of color image parameters stored in an image parameter memory of the facsimile apparatus of FIG. 9;

FIGS. 19-26 are flowcharts for respectively explaining modified procedures of the facsimile receiving and transmission operation performed by the facsimile apparatus of FIG. 9;

FIG. 27 is another table of color image parameters stored in an image parameter memory of the facsimile apparatus of FIG. 9; and

FIGS. 28 and 29 are flowcharts for respectively explaining modified procedures of the facsimile receiving and transmission operation performed by the facsimile apparatus of FIG. 9.

### DETAILED DESCRIPTION

In describing preferred embodiments illustrated in the drawings, specific terminology is employed for the sake of clarity. However, the invention is not intended to be limited to the specific terminology so selected and it is to be understood that each specific element includes all technical equivalents which operate in a similar manner.

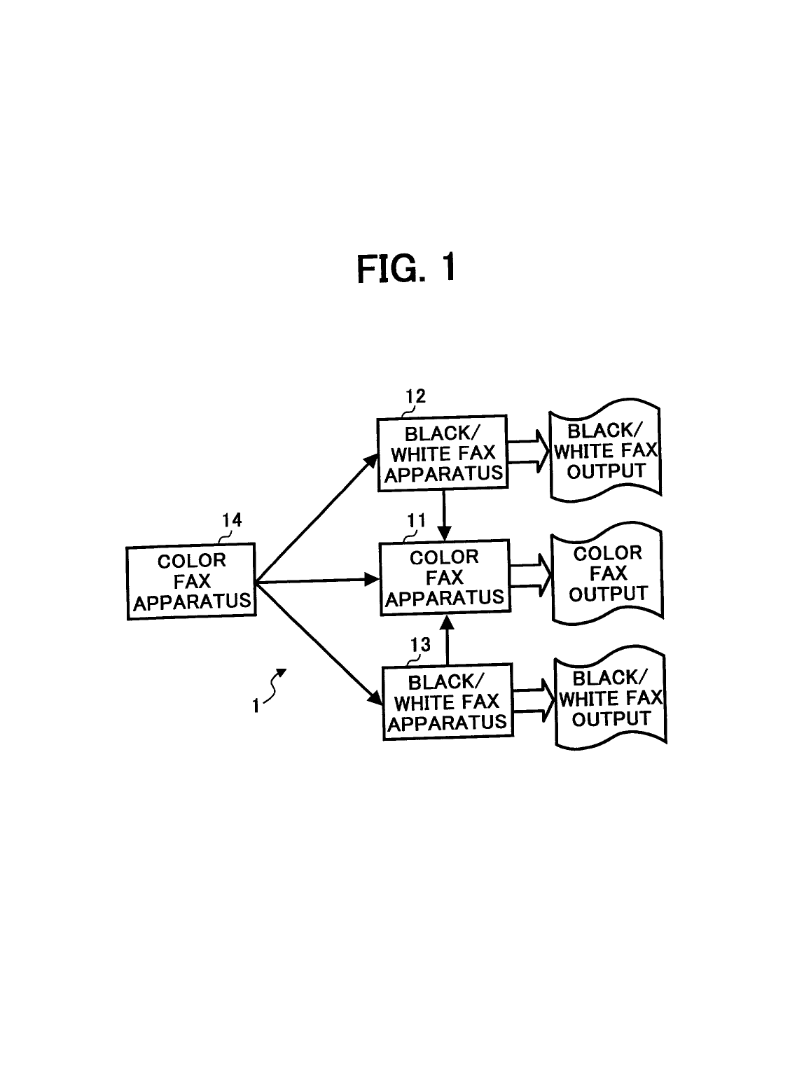

Referring now to the drawings, wherein like reference numeral designate identical or corresponding parts throughout the several views, particularly to FIG. 1, a facsimile system 1 according to an embodiment of the present application is described. The facsimile system 1 of FIG. 1 includes a color facsimile apparatus 11 for handling color images and black-and-white facsimile apparatuses 12 and 13 for handling black-and-white images. Each of the numbers of the color and black-and-white facsimile apparatuses is not limited to that applied in the facsimile system 1 of FIG. 1. When the facsimile apparatuses 12 and 13 receive a black-and-white image from another facsimile apparatus, they normally output a black-and-white image. In addition, the facsimile apparatuses 12 and 13 are capable of performing a color image handling operation although they are not capable of outputting color images. That is, the facsimile apparatuses 12 and 13 transfer a color image to the color facsimile apparatus 11 included in the facsimile system 1 upon a receipt of a color image from an external apparatus such as a color facsimile apparatus 14, for example. Thus, the color image received from the external apparatus can be output within the facsimile system 1.

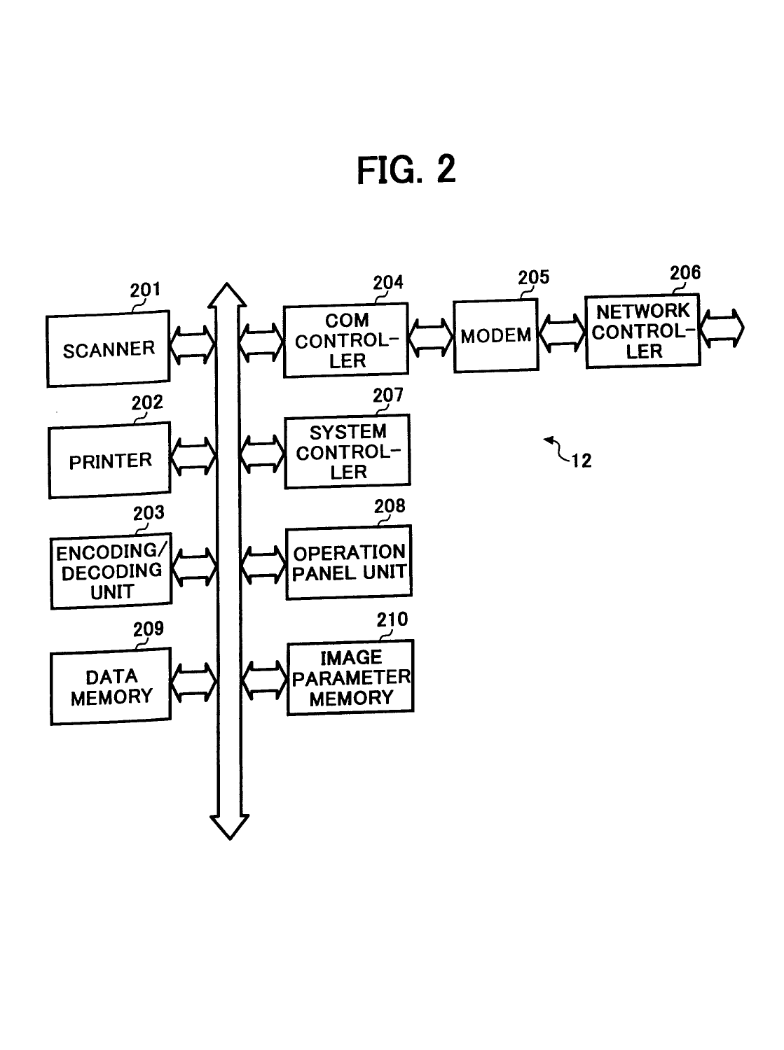

Referring to FIG. 2, an exemplary structure of the facsimile apparatus 12 of FIG. 1 is explained. As shown in FIG. 2, the facsimile apparatus 12 includes a scanner 201, a printer 202, an encoding/decoding unit 203, a communications controller 204, a modem 205, a network controller 206, a system controller 207, an operation panel unit 208, a data memory 209, and an image parameter memory 210. The scanner 201 reads an original. The printer 202 reproduces an image when the facsimile apparatus 12 receives a black-and-white image. The encoding/decoding unit 203 encodes image information to be transmitted to and decodes image information which has been received from another facsimile machine. The communications controller 204 responses to a call, received from another facsimile machine, with information of capabilities for a color facsimile and performs protocol controls. The modem 205 modulates and demodulates communications data. The network controller 206 is connected to a telephone line and is capable of initiating and receiving a call. The system controller 207 performs a facsimile operation in a predetermined manner.

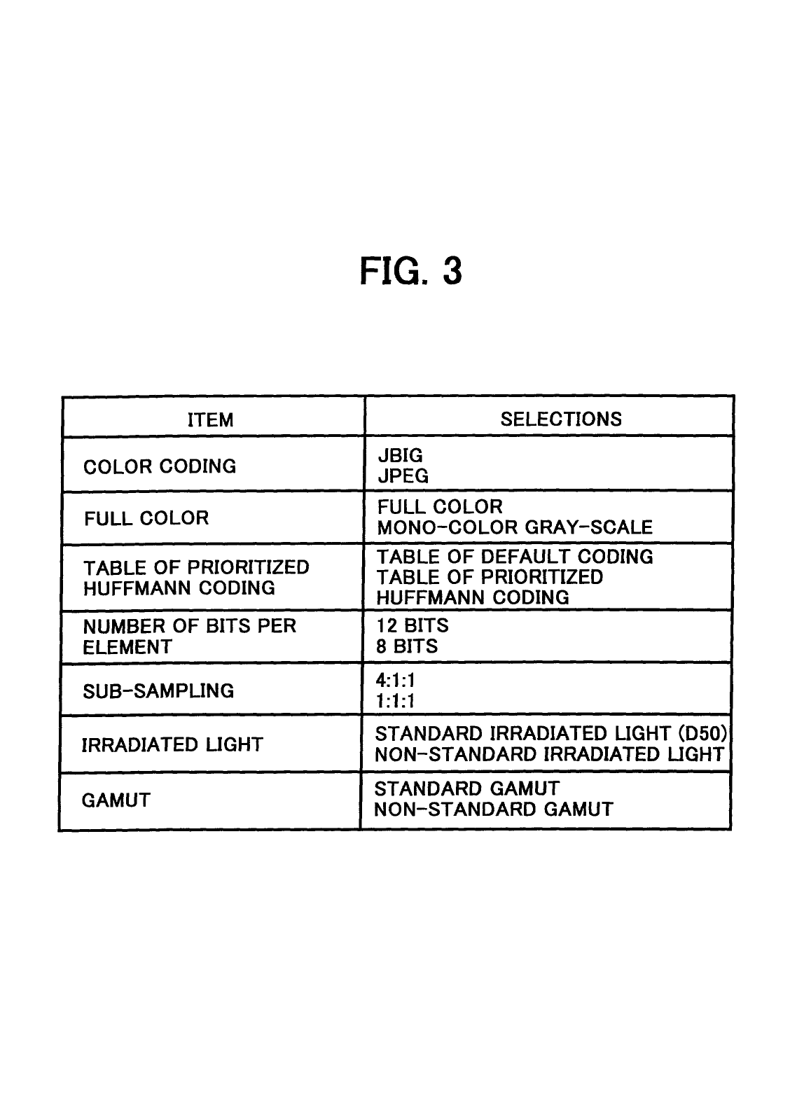

The operation panel unit 208 allows data input by the user for registration of a color facsimile machine to which facsimile information received from another facsimile machine will be transferred when it is in color. The data memory 209 stores information of the registration input by the user through the operation panel unit 208. In this example, the color facsimile apparatus 11 is registered in the data memory 209, for example. The information of the registration includes communications capabilities of the registered color facsimile machine for receiving a call. The operation panel unit 208 allows the user to select valid or invalid of a color receiving function provided to the facsimile apparatus 12. The image parameter memory 210 stores a set of color image parameters which are selectively used for various types of color images sent from other color facsimile machines. FIG. 3 shows an exemplary table of the color image parameters stored in the image parameter memory 210.

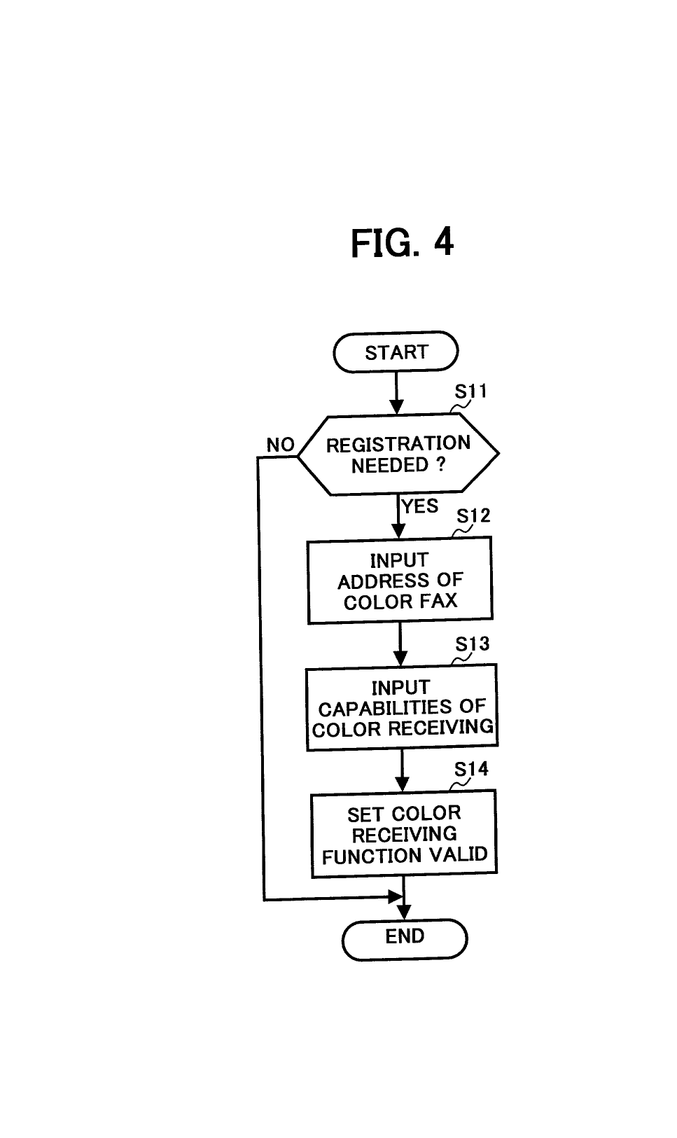

FIG. 4 shows an exemplary procedure of the registration of a color facsimile machine to which color facsimile information is transferred. As shown in FIG. 4, the system controller 207 determines in Step S11 if the registration is needed. If the registration is determined as needed in Step S11, the procedure of the registration is started. In Step S12, a transferable color facsimile machine is input by the user. That is, in this case, the address of the color facsimile apparatus 11 is input by the user. Then, in Step S13, capabilities of facsimile receiving pertinent to the color facsimile apparatus 11 are input by the user. In Step S14, the color receiving function is set valid by the user through the operation panel unit 208.

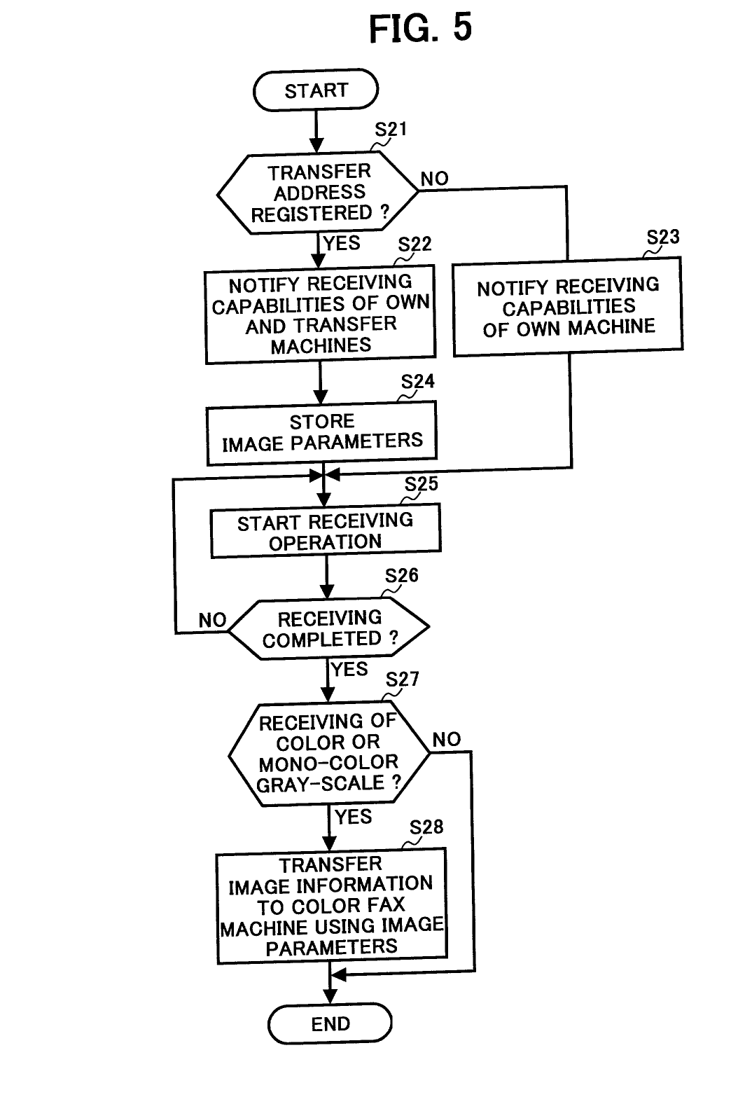

Referring to FIG. 5, an exemplary procedure of the receiving/transfer operation performed by the facsimile apparatus 12 is explained. In Step S21, the system controller 207 determines if the registration for the color image transfer operation is made and the color receiving function is set valid. If the registration for the color image transfer operation is determined as being made and the color receiving function is determined as being set valid, in Step S21, the process proceeds to Step S22 in which the system controller 207 notifies a calling facsimile machine of receiving capability information that includes its own receiving capabilities and those of the color facsimile apparatus registered and then starts the communications. In Step S24, at the beginning of the communications, the system controller 207 receives color image parameters sent from the calling facsimile machine before starting the receiving operation and stores them in the image parameter memory 210. After that, the process proceeds to Step S25.

If the registration for the color image transfer operation is determined as not being made and/or the color image receiving function is determined as not being set valid, in Step S21, the process proceeds to Step S23. In this case, in Step S23, the system controller 207 notifies the calling facsimile machine of receiving capability information that includes its own receiving capabilities and then starts the communications. After that, the process proceeds to Step S25.

In Step S25, the system controller 207 receives image information. In Step S26, the system controller 207 determines if the receiving operation has been completed. If the receiving operation is determined as having been completed, the system controller 207 determines in Step S27 if the received image information includes color data or mono-color gray-scale data. If the received image information is determined as including color data or mono-color gray-scale data, the process proceeds to Step S28. In Step S28, the system controller 207 transfers the received image information to the color facsimile apparatus 11 using the color image parameters stored in the image parameter memory 210 in Step S24. Then, the process ends. If the received image information is determined as not including color data or mono-color gray-scale data, the process also ends.

By the structure as described above, the facsimile apparatus 12 can receive color facsimile information and transfer it to a registered color facsimile machine. This allows the facsimile system 1 to receive color facsimile information, sent from an external facsimile machine, by any one of the facsimile machines even when the facsimile system 1 has only a single color facsimile apparatus 11.

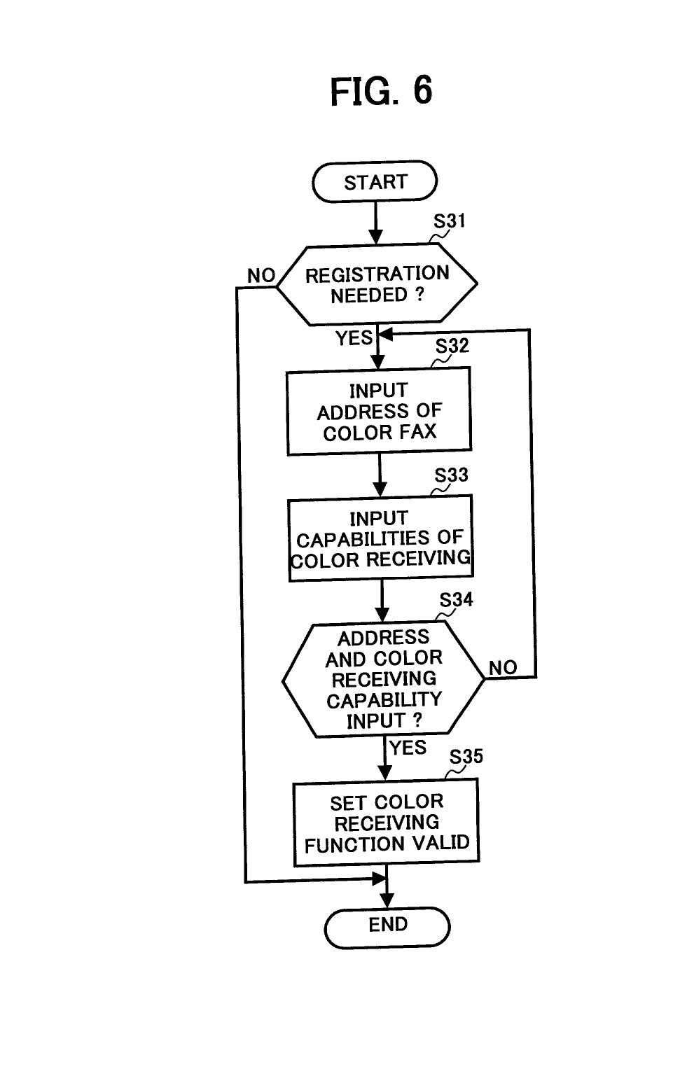

FIG. 6 shows another exemplary procedure of the registration of a color facsimile machine to which color facsimile information is transferred. The procedure of FIG. 6 is similar to that of FIG. 4, except for determination in Step S34. That is, in Step S31, the system controller 207 determines if the registration is needed. If the registration is determined as needed in Step S31, the procedure of the registration is started. The address and the facsimile receiving capabilities of the color facsimile apparatus 11 are input, in Steps S32 and S33, respectively. Then, in Step S34, the system controller 207 determines if the address and the facsimile receiving capabilities of the color facsimile apparatus 11 are input. If the address and the facsimile receiving capabilities of the color facsimile apparatus 11 are determined as input, the system controller 207 sets the color receiving function valid, in Step S35.

With the above structure, the facsimile apparatus 12 automatically performs the operation for setting the color receiving function valid upon determining a completion of the input of the address and the facsimile receiving capabilities of the color facsimile apparatus 11. This eliminates an erroneous event in that the facsimile apparatus 12 cannot receive color facsimile information although the color facsimile apparatus is registered since if for any reason the color receiving function has not been set to valid.

If the facsimile apparatus 12 can transfer image information to use not only a color capability but also other capabilities of another facsimile machine, which is not provided to the facsimile apparatus 12, the system controller 207 checks the contents of the input receiving capabilities and sets the color receiving function valid upon determining that the input receiving capabilities include the color capabilities.

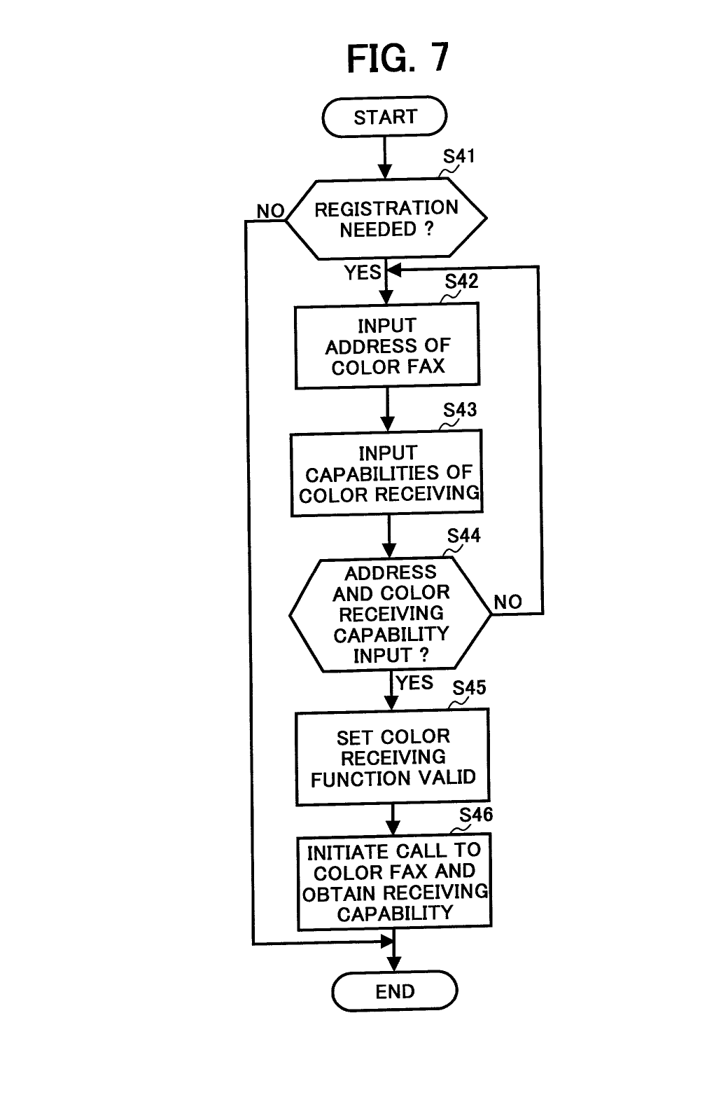

FIG. 7 shows another exemplary procedure of the registration of a color facsimile machine to which color facsimile information is transferred. The procedure of FIG. 7 is similar to that of FIG. 4, except for a call initiation to the registered color facsimile apparatus 11 in Step S46. That is, in Step S41, the system controller 207 determines if the registration is needed. If the registration is determined as needed in Step S41, the procedure of the registration is started. The address and the facsimile receiving capabilities of the color facsimile apparatus 11 are input, in Steps S42 and S43, respectively. Then, in Step S44, the system controller 207 determines if the address and the facsimile receiving capabilities of the color facsimile apparatus 11 are input. If the address and the facsimile receiving capabilities of the color facsimile apparatus 11 are determined as input, the system controller 207 sets the color receiving function valid in Step S45. After that, in Step S46, the system controller 207 initiates a call to the registered color facsimile apparatus 11 so as to receive and store the detailed receiving capabilities of the registered color facsimile apparatus 11.

With the above procedure, the facsimile apparatus 12 can automatically register the detailed receiving capabilities of the registered color facsimile apparatus 11 including a color or a mono-color gray-scale image receiving capability. This avoids a need for expert knowledge normally required when a color or a mono-color gray-scale image receiving capability is registered.

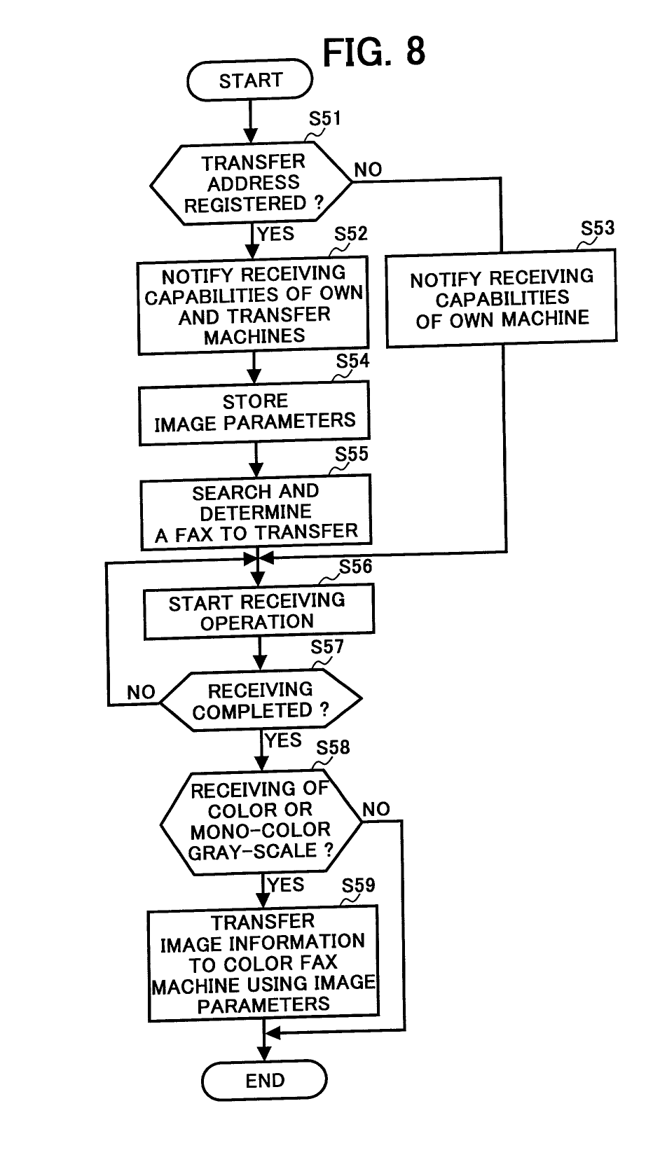

Referring to FIG. 8, another exemplary procedure of the receiving/transfer operation performed by the facsimile apparatus 12 is explained. In this case, it is supposed that a plurality of color facsimile machines including the color facsimile apparatus 11 are registered. The procedure of FIG. 8 is similar to that of FIG. 5, except for determination of a facsimile machine to which to transfer color facsimile image information. That is, in Step S51, the system controller 207 determines if the registration for the color image transfer operation is made and the color receiving function is set valid. If the registration for the color image transfer operation is determined as being made and the color receiving function is determined as being set valid, in Step S51, the process proceeds to Step S52 in which the system controller 207 notifies a calling facsimile machine of receiving capability information that includes its own receiving capabilities and those of the color facsimile apparatus registered and then starts the communications. In Step S54, at the beginning of the communications, the system controller 207 receives color image parameters sent from the calling facsimile machine before starting the receiving operation and stores them in the image parameter memory 210. After that, in Step S55, a suitable color facsimile machine is selected from among the plurality of the color facsimile machines and is determined. In this case, it is supposed that the color facsimile apparatus 11 is selected and determined as a machine where to transfer the color facsimile image information. Then, the process proceeds to Step S56.

If the registration for the color image transfer operation is determined as not being made and/or the color receiving function is determined as not being set valid, in Step S51, the process proceeds to Step S53. In this case, in Step S53, the system controller 207 notifies the calling facsimile machine of receiving capability information that includes its own receiving capabilities and then starts the communications. After that, the process proceeds to Step S56.

In Step S56, the system controller 207 receives image information. In Step S57, the system controller 207 determines if the receiving operation has been completed. If the receiving operation is determined as having been completed, the system controller 207 determines in Step S58 if the received image information includes color data or mono-color gray-scale data. If the received image information is determined as including color data or mono-color gray-scale data, the process proceeds to Step S59. In Step S59, the system controller 207 transfers the received image information to the selected color facsimile apparatus 11 using the color image parameters stored in the image parameter memory 210 in Step S54. Then, the process ends. If the received image information is determined as not including color data or mono-color gray-scale data, the process also ends.

During the above procedure, the system controller 207 conducts the facsimile receiving operation according to a Group 3 facsimile procedure and, if the color facsimile apparatus 11 is a Group 4 machine, the system controller 207 conducts conversion of transmission protocols so as to perform transmission according to the Group 4 procedure.

In an environment where the receiving operation and the transmission operation differ in communications methods, the facsimile apparatus 12 can transfer the facsimile image information.

By the structure as described above, the facsimile apparatus 12 converts the color image parameters according to a type of a machine to which color facsimile image information is transferred and transfers the information using the converted color image parameters when using different telephone lines for receiving and transmission.

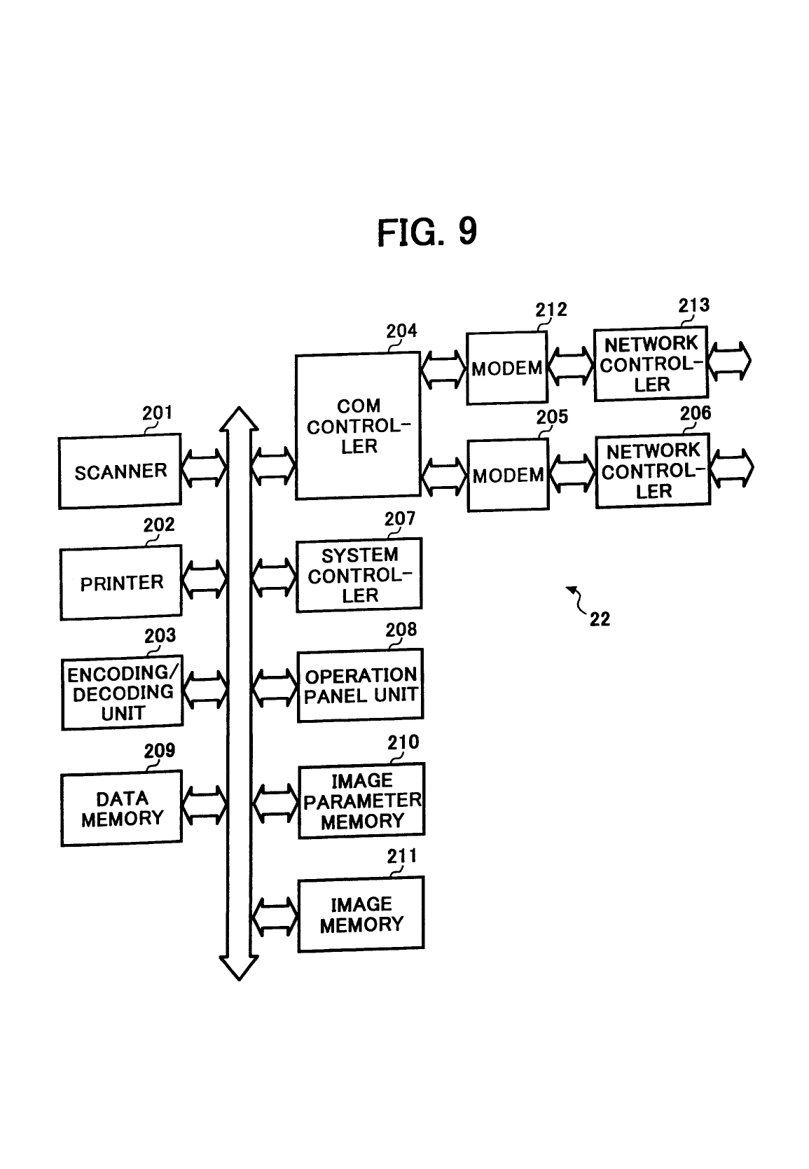

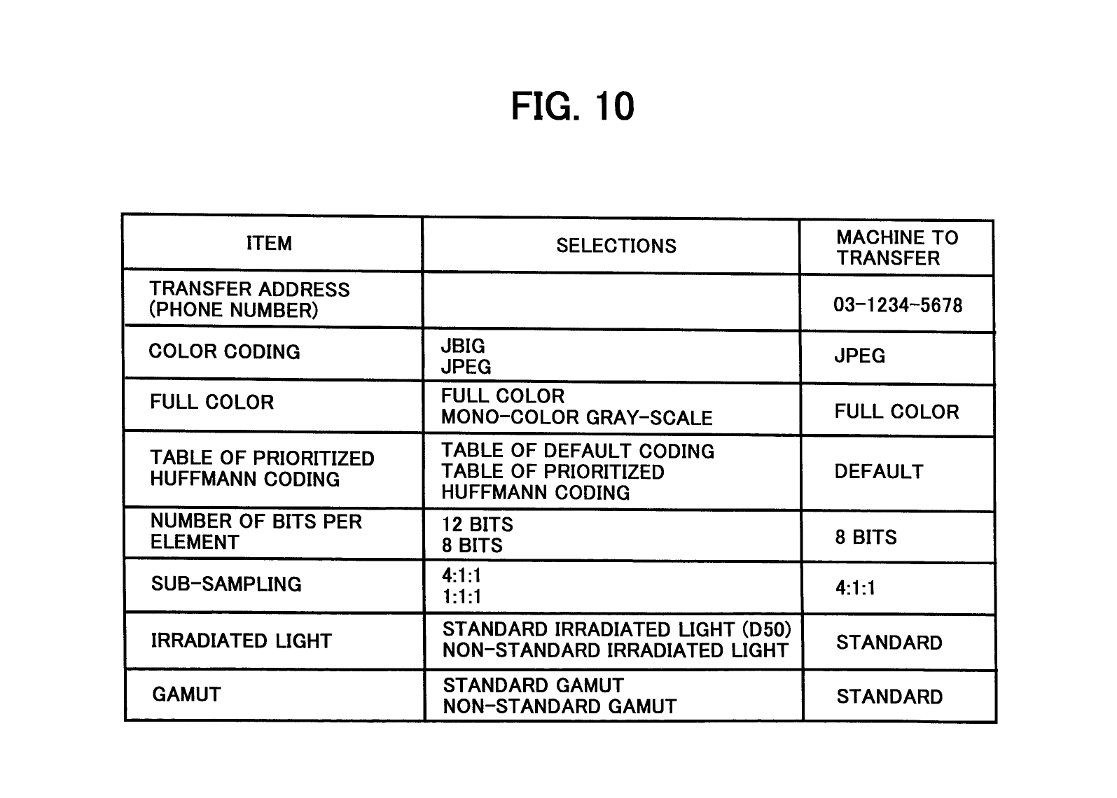

Referring now to FIG. 9, another exemplary structure of the black/white facsimile apparatus according to an embodiment of the present application. A facsimile apparatus 22 is shown in FIG. 9, which is capable of outputting black/white images. The facsimile apparatus 22 of FIG. 9 is similar to the facsimile apparatus 12 of FIG. 2, except for addition of an image memory 211, another modem 212, and another network controller 213. The image memory 211 stores facsimile image information. The modem 212 and the network controller 213 cooperate with each other to perform a transfer operation for transferring color facsimile image information at the same time that the modem 205 and the network controller 206 perform the facsimile receiving operation. A table of color image parameters relating to color is stored in the image parameter memory 210, as shown in FIG. 10.

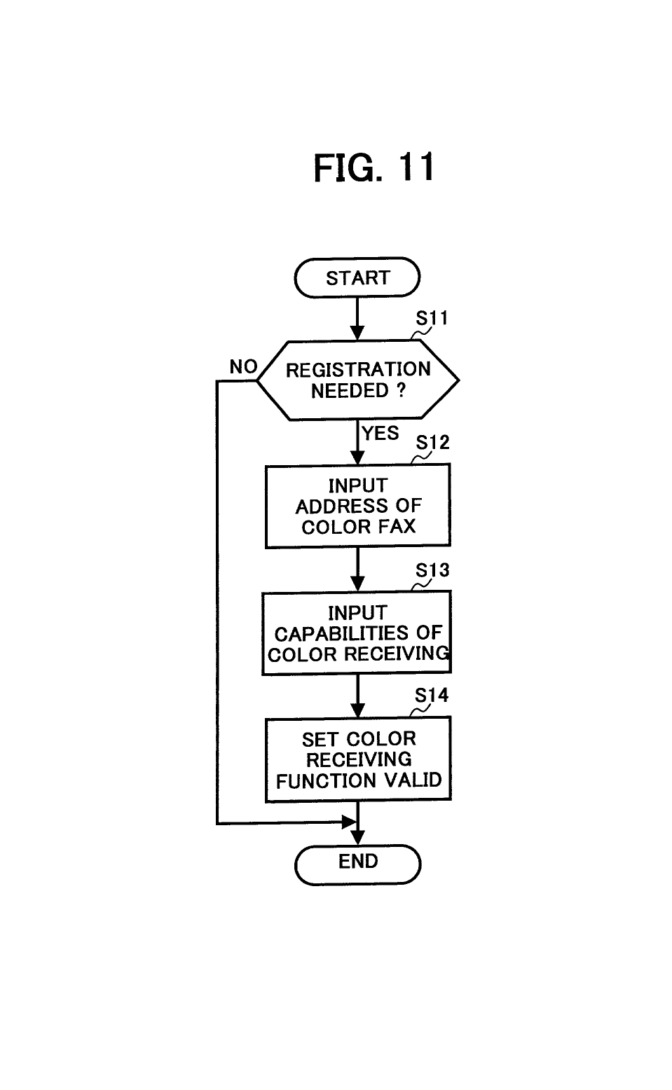

An exemplary procedure of the registration, performed by the facsimile apparatus 22, with respect to a transfer machine which is the color facsimile apparatus 11, for example, is shown in FIG. 11. The procedure of FIG. 11 is similar to that of FIG. 4. Therefore, for convenience sake, the steps of the procedure shown in FIG. 11 that perform similar operations are labeled with the same reference figures as those of FIG. 4. That is, when the user starts the registration of the transfer machine (Step S11), the user inputs an address of the transfer machine (Step S12) and the capabilities of the receiving operation (Step S13). After that, the user sets the color receiving function valid (Step S14).

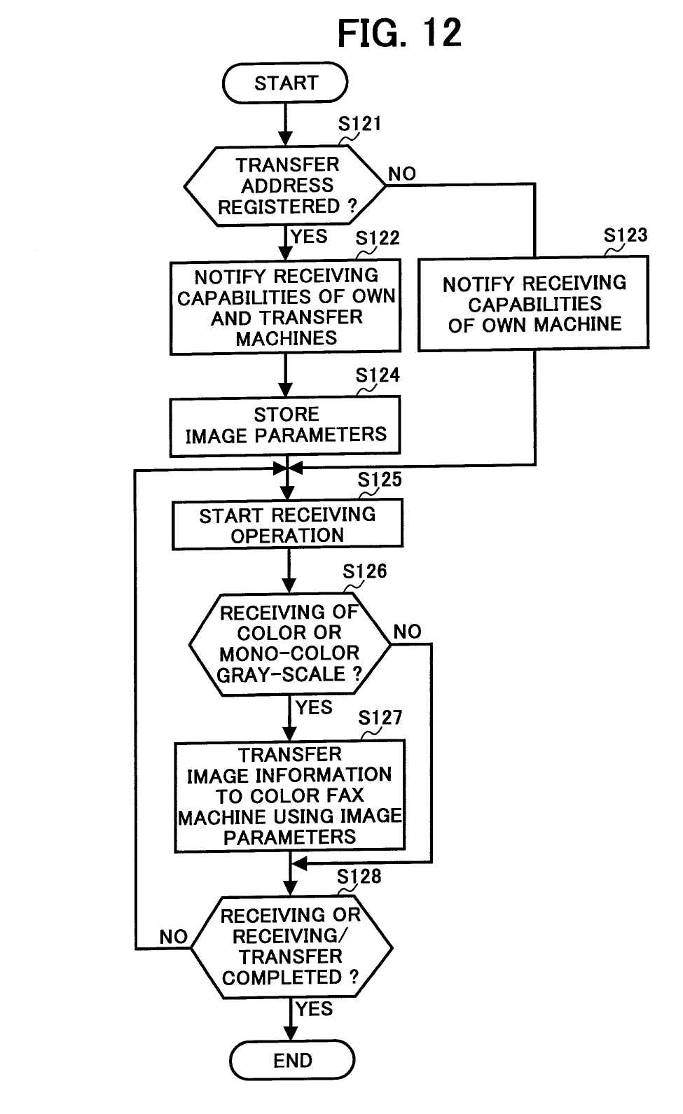

FIG. 12 shows an exemplary procedure of the receiving/transfer operation performed by the facsimile apparatus 22 of FIG. 9. In Step S121, the system controller 207 of the facsimile apparatus 22 determines if the registration for the color image transfer operation is made and the color image receiving function is set valid. If the registration for the color image transfer operation is determined as being made and the color receiving function is determined as being set valid, in Step S121, the process proceeds to Step S122 in which the system controller 207 notifies a calling facsimile machine of receiving capability information that includes its own receiving capabilities and those of the color facsimile apparatus 11 registered and then starts the communications. In Step S124, at the beginning of the communications, the system controller 207 receives color image parameters sent from the calling facsimile machine before starting the receiving operation and stores them in the image parameter memory 210. After that, the process proceeds to Step S125.

If the registration for the color image transfer operation is determined as not being made and/or the color receiving function is determined as not being set valid, in Step S121, the process proceeds to Step S123. In this case, in Step S123, the system controller 207 notifies the calling facsimile machine of receiving capability information that includes its own receiving capabilities and then starts the communications. After that, the process proceeds to Step S125.

In Step S125, the system controller 207 receives image information. In Step S126, the system controller 207 determines if the received image information includes color data or mono-color gray-scale data. If the received image information is determined as including color data or mono-color gray-scale data, the process proceeds to Step S127 in which the system controller 207 transfers the received image information to the color facsimile apparatus 11 using the color image parameters stored in the image parameter memory 210 in Step S124. If the received image information is determined as not including color data or mono-color gray-scale data, in Step S126, the process proceeds to Step S128. In this case, since the received facsimile image information is in black and white, the system controller 207 afterwards conducts the printing of the facsimile image with the printer 202.

In Step S128, the system controller 207 determines if the receiving operation performed in Step S125 has been completed. If the receiving operation is determined as completed, the process ends. But, if the receiving operation is determined as not completed, the process returns to Step S125.

By the structure as described above, the facsimile apparatus 22 can receive color facsimile information and immediately start to transfer it to a registered color facsimile machine upon a determination that the received facsimile image information includes color data or mono-color gray-scale data. This allows the facsimile system 1 to save the space of the image memory 211 since color information normally includes a great amount of data.

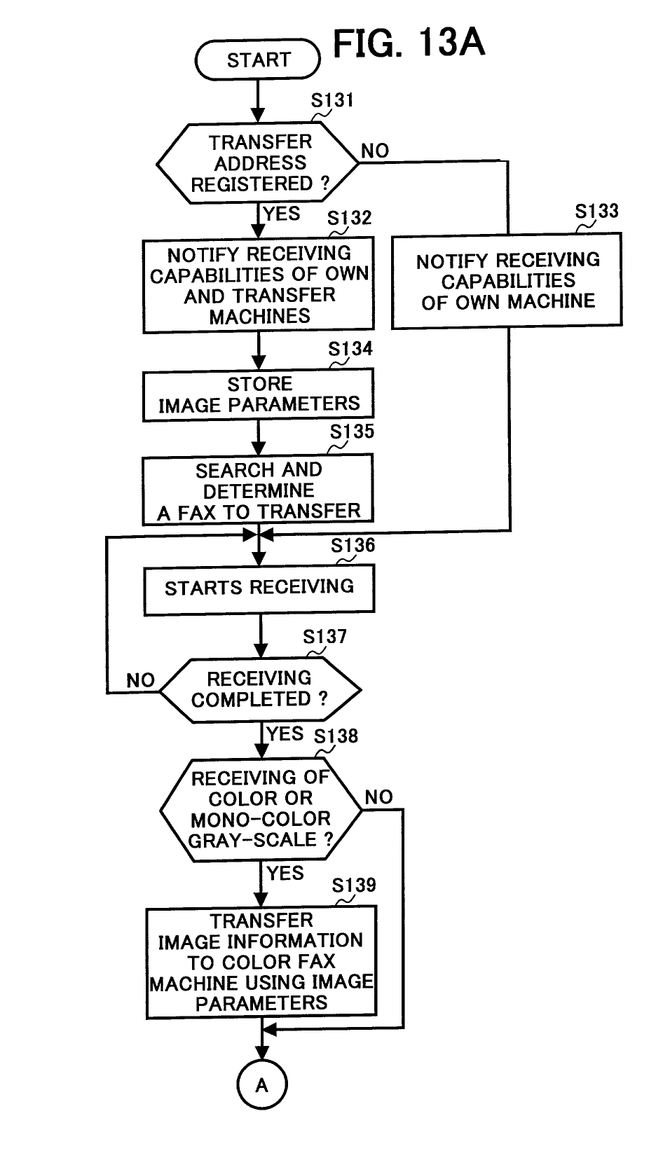

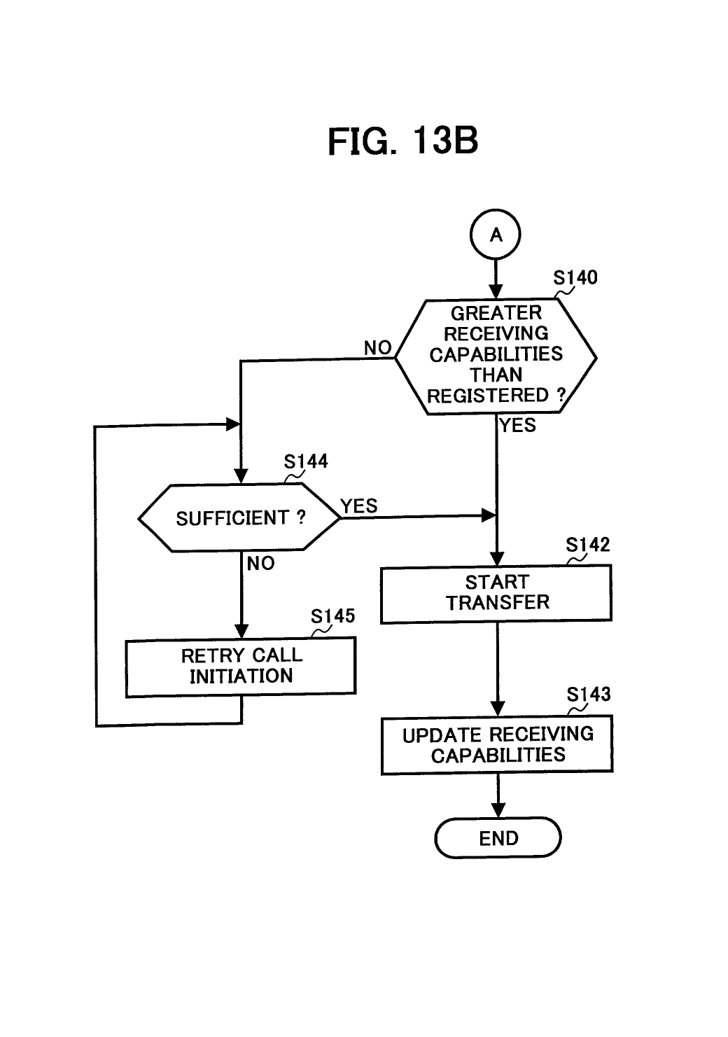

FIG. 13 shows another exemplary procedure of the receiving/transfer operation performed by the facsimile apparatus 22 of FIG. 9. According to the procedure of FIG. 13, the facsimile apparatus 22 updates the color data receiving capabilities of the registered color facsimile apparatus 11 each time an event of paper out or color toner out occurs on the registered color facsimile apparatus 11.

Since Steps S131-S139 of FIG. 13 correspond to Steps S51-S59 of FIG. 8, the description of Steps S131-S139 is omitted. The process proceeds to Step S140 after the system controller 207 transfers the received image information to the registered color facsimile apparatus 11, selected in Step S135, using the color image parameters stored in the image parameter memory 210 in Step S134. In Step S140, the system controller determines if the receiving capabilities received from the color facsimile apparatus 11 are greater than those stored in the image parameter memory 210. If the receiving capabilities are determined as greater than those stored in the image parameter memory 210, the system controller 207 conducts the transfer of the received color facsimile image information to the registered color facsimile apparatus 11, in Step S142. Then, in Step S143, the system controller 207 updates the receiving capabilities stored in the image parameter memory 210 with the newly received capabilities.

If the receiving capability is determined as not greater than those stored in the image parameter memory 210, the system controller 207 further determines if the receiving capability of the color facsimile apparatus 11 is sufficient for receiving the color image data. If the receiving capability of the color facsimile apparatus 11 is determined as sufficient, the process proceeds to Step S142 so that the system controller 207 performs the transfer operation. If the receiving capability of the color facsimile apparatus 11 is determined as not sufficient, the process proceeds to Step S145 in which the system controller 207 goes into a waiting mode with initiating a call to the color facsimile apparatus 11 at intervals of a predetermined time period so as to wait until the system controller 207 receives from the color facsimile apparatus 11 the color capabilities to be determined as at least sufficient for the color data transfer.

By the above-described structure, the facsimile apparatus 22 can update the color image receiving capabilities of the registered color facsimile apparatus in a timely manner. This improves the performance for handling the color facsimile image of the facsimile apparatus 22.

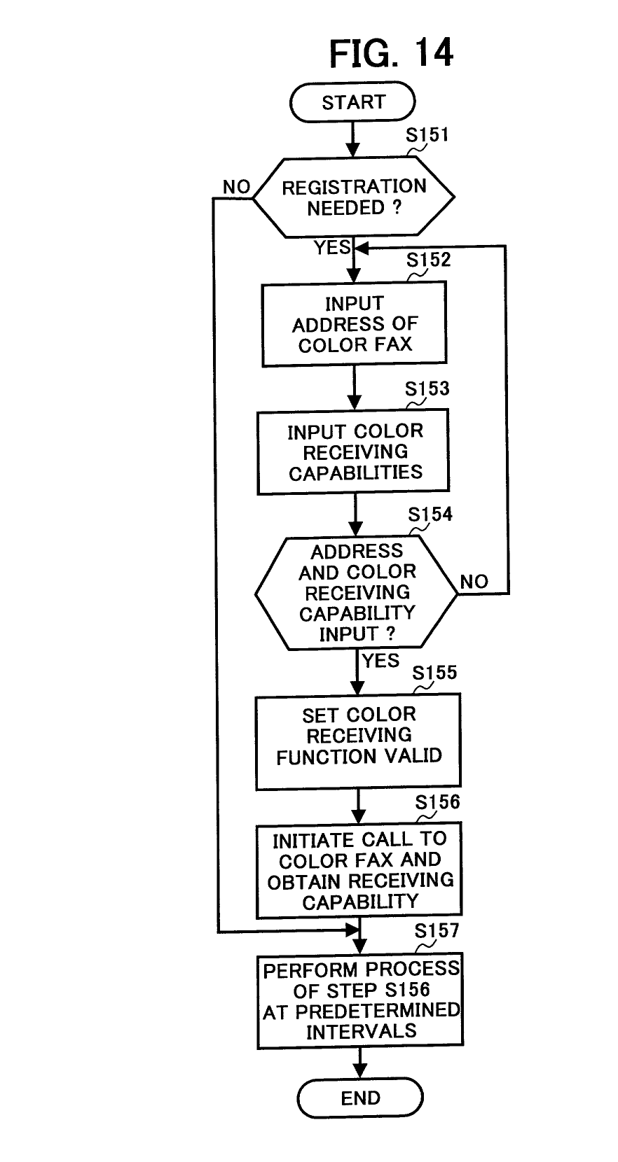

FIG. 14 shows another exemplary procedure of the registration of a transfer machine performed by the facsimile apparatus 22. According to the procedure of FIG. 14, the facsimile apparatus 22 initiates a call to the registered color facsimile apparatus 11 at intervals of a predetermined time period to detect an event of paper out or color toner out that occurs on the registered color facsimile apparatus 11 so as to update the color data receiving capabilities of the registered color facsimile apparatus 11.

Since Steps S151-S156 of FIG. 14 correspond to Steps S41-S46 of FIG. 7, the description of Steps S151-S156 of FIG. 14 are omitted. The system controller 207 performs the automatic call initiation relative to the registered color facsimile apparatus 11 to obtain the receiving capabilities and to store the data into the image parameter memory 210. In Step S157, the system controller 207 repeat this operation performed in Step S156 at intervals of a predetermined time period.

By this structure, the facsimile apparatus 22 can update the receiving capabilities of the registered color facsimile apparatus at intervals of a predetermined time period through the transfer machine registration operation.

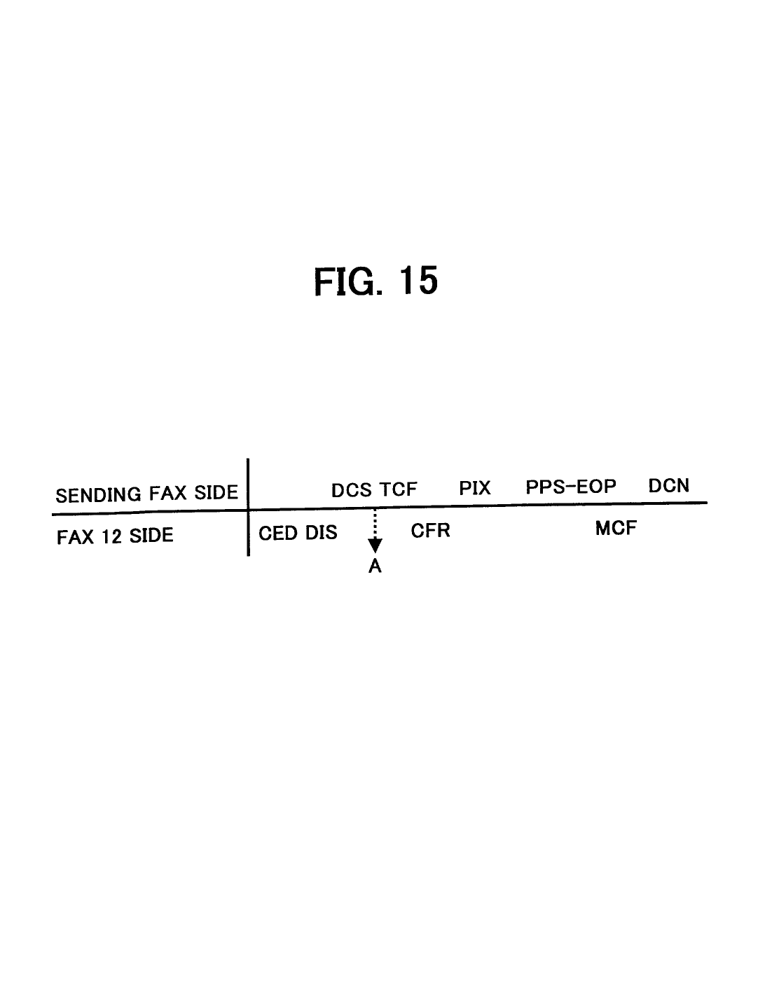

FIG. 15 shows a time A at which the facsimile apparatus 22 detects that the received facsimile image information includes color or mono-color gray-scale data. Whether the received facsimile image information includes color or mono-color gray-scale data can be determined by analyzing the contents of a DCS (digital command signal) signal which is sent from the sending facsimile side at the beginning of the communications. That is, the DCS signal is the first occasion to determine whether the received facsimile image information includes the color or mono-color gray-scale data.

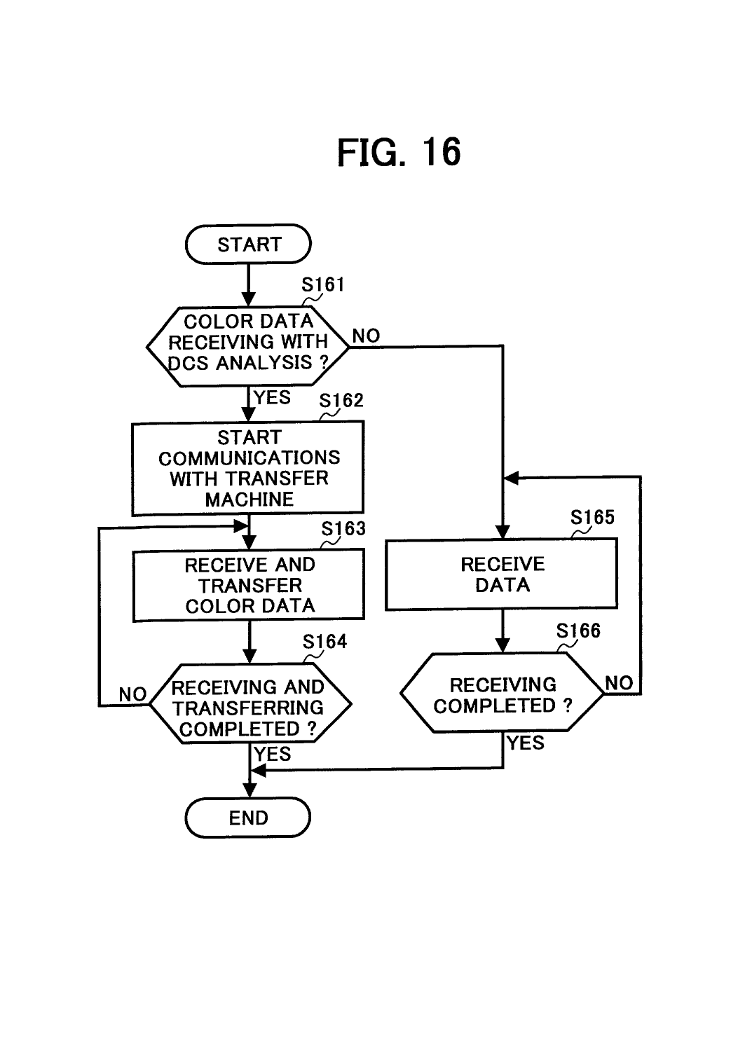

FIG. 16 shows an exemplary procedure of a DCS-analysis-based facsimile receiving operation performed by the facsimile apparatus 22. Upon starting the communications with a sending facsimile machine, the system controller 207 of the facsimile apparatus 22 determines in Step S161 if the facsimile information sent from the sending facsimile machine includes color or mono-color gray-scale data by performing the DCS analysis. If the facsimile information is determined as including color or mono-color gray-scale data, the system controller 207 immediately initiate a call to the registered color facsimile apparatus 11, in Step S162. Then, the system controller 207 conducts the facsimile receiving operation and the color image transfer operation in parallel, in Step S163. The system controller 207 then determines if the facsimile receiving operation and the color image transfer operation are completed. If the facsimile receiving operation and the color image transfer operation are completed, the process ends.

In Step S161, if the facsimile information is determined as not including color or mono-color gray-scale data, the system controller 207 starts the facsimile receiving operation, in Step S165. In this case, the received facsimile image is soon reproduced by the printer 202. Then, in Step S166, the system controller 207 checks if the facsimile receiving operation is completed. If the facsimile receiving operation is completed and the check result of Step S166 is YES, the process ends.

With the above structure, the facsimile apparatus 22 can detect whether the receiving facsimile information includes color or mono-color gray-scale data by performing the DCS analysis so as to conduct parallel operations of the receiving and transmission with respect to the color facsimile data.

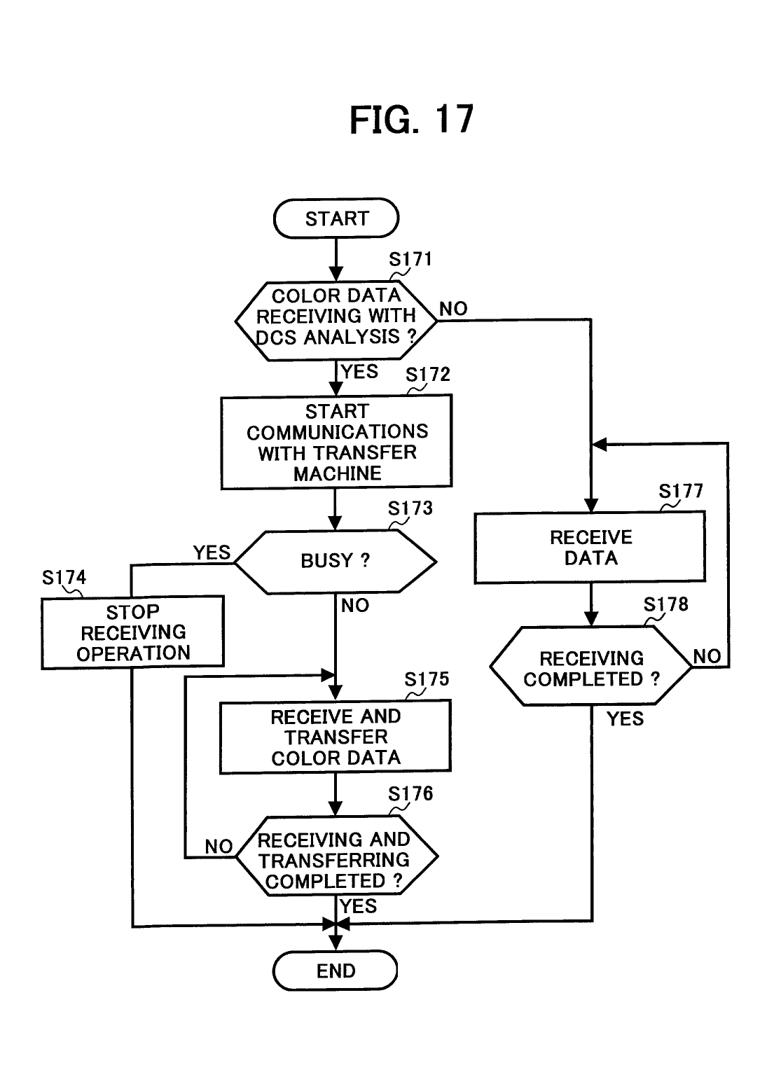

FIG. 17 shows another exemplary procedure of the DCS-analysis-based facsimile receiving operation performed by the facsimile apparatus 22. The procedure of FIG. 17 is similar to that of FIG. 16, except for Steps S173 and S174. The facsimile apparatus 22 determines in Step S173 if the transfer machine, which is the registered color facsimile apparatus 11, is busy after starting the communications with the transfer machine in Step S172. If the transfer machine is determined as busy, the system controller 207 stops the facsimile receiving operation, in Step S174. This is because if the receiving operation is continued the image memory 211 will overflow with the color data. Then, the process ends.

If the transfer machine is determined as not busy, the system controller 207 conducts the receiving and transferring operations in parallel, in Step S175. Then, in Step S176, the system controller 207 determines if the receiving and transferring operations are completed. If the receiving and transferring operations are determined as completed, the process ends.

With the above structure, the facsimile apparatus 22 can terminate the operation of receiving the color data when the transfer machine is busy so as to avoid occurrence of memory overflow.

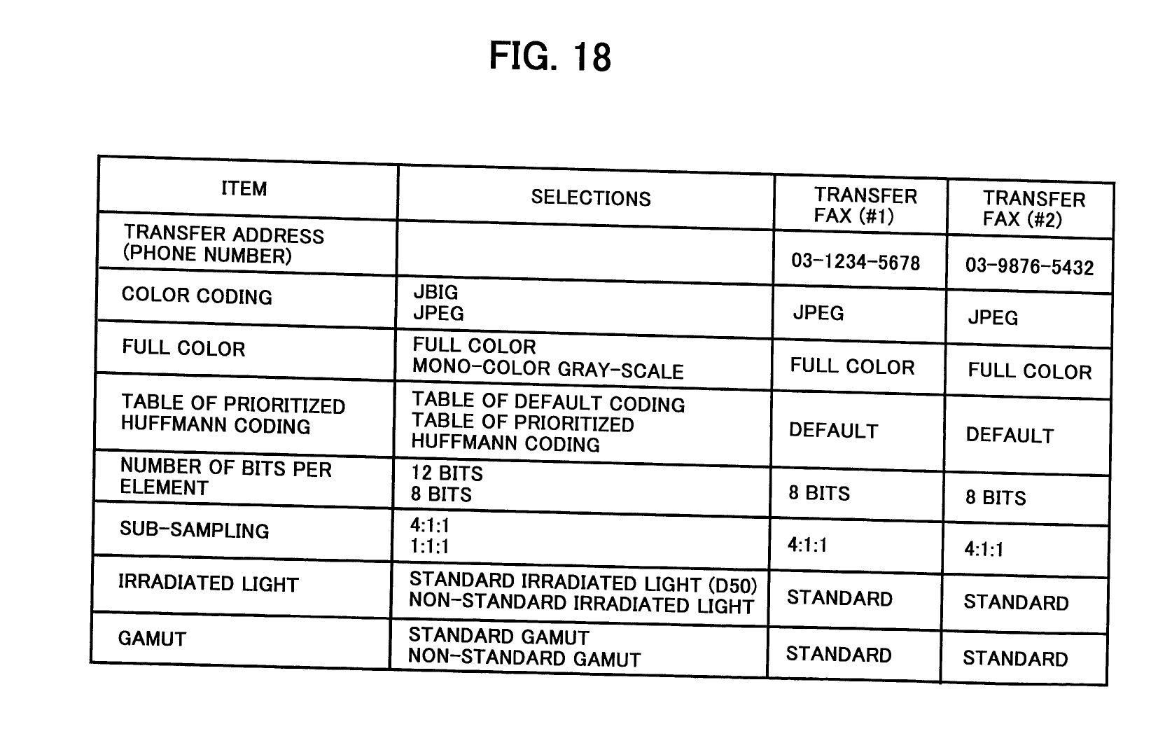

FIG. 18 shows another table of color image parameters relating to color stored in the image parameter memory 210 of the facsimile apparatus 22.

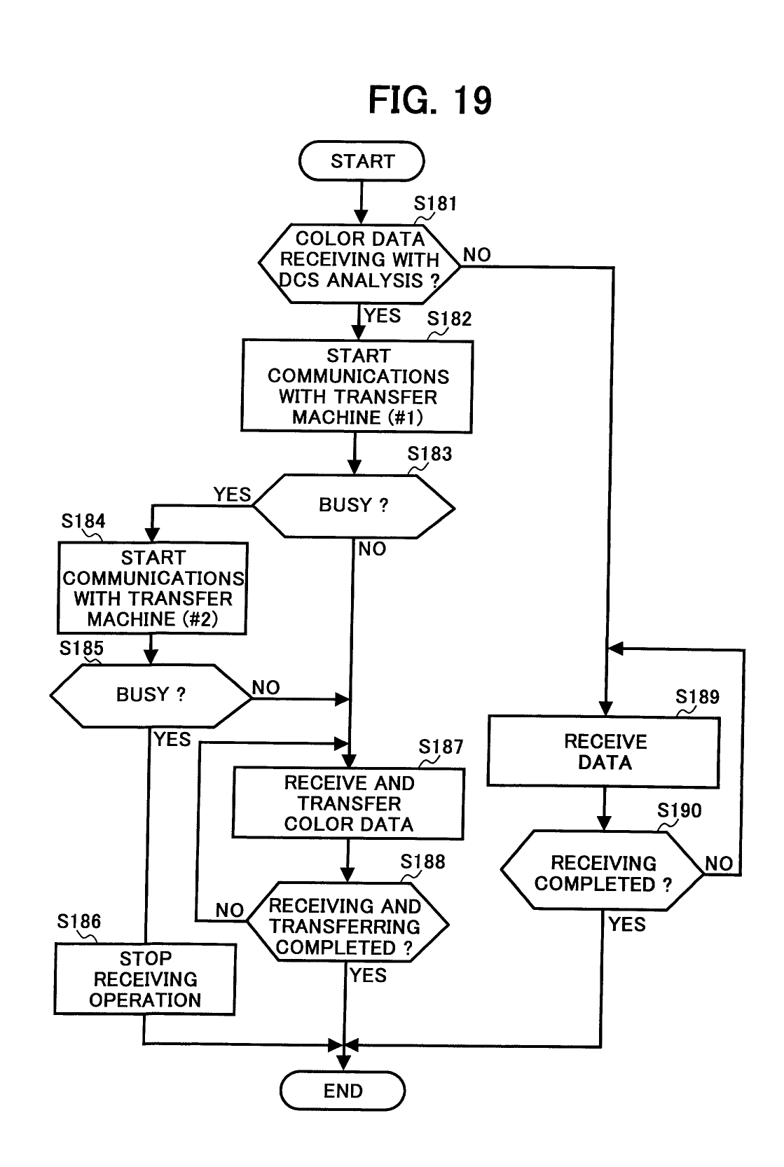

FIG. 19 shows another exemplary procedure of the DCS-analysis-based facsimile receiving operation performed by the facsimile apparatus 22. In this case, two color facsimile apparatuses are registered in the facsimile apparatus 22, as shown in the table of color image parameters of FIG. 18. The procedure of FIG. 19 is similar to that of FIG. 16, except for Step S182, S184, S185, and S186.

In the procedure of FIG. 19, if the system controller 207 of the facsimile apparatus 22 determines in Step S181 that the receiving facsimile information includes color or mono-color gray-scale data, the system controller 207 initiates in Step S182 a call to the first registered color facsimile apparatus using the telephone number registered in the table of FIG. 18 and starts the transfer of the receiving color data. Then, the system controller 207 determines in Step S183 if the first registered color facsimile apparatus is busy. If the first registered color facsimile apparatus is determined as busy, the system controller 207 initiates in Step S184 a call to the second registered color facsimile apparatus using the telephone number registered in the table of FIG. 18 and starts the transfer of the receiving color data to the second registered color facsimile apparatus. In Step S185, the system controller 207 further determines if the second registered color facsimile apparatus is busy. If the second registered color facsimile apparatus is determined as busy, the system controller 207 stops in Step S186 the facsimile receiving operation. This is because if the receiving operation is continued the image memory 211 will overflow with the color data. After that, the process ends.

If the first registered color facsimile apparatus is determined as not busy in Step S183 or if the second registered color facsimile apparatus is determined as not busy in Step S185, the system controller 207 conducts the receiving and transferring operations in parallel, in Step S187. Then, in Step S188, the system controller 207 determines if the receiving and transferring operations are completed. If the receiving and transferring operations are determined as completed, the process ends.

With the above structure, the facsimile apparatus 22 can switch the color data transfer operation from one color machine to another color machine when the first machine is detected as busy.

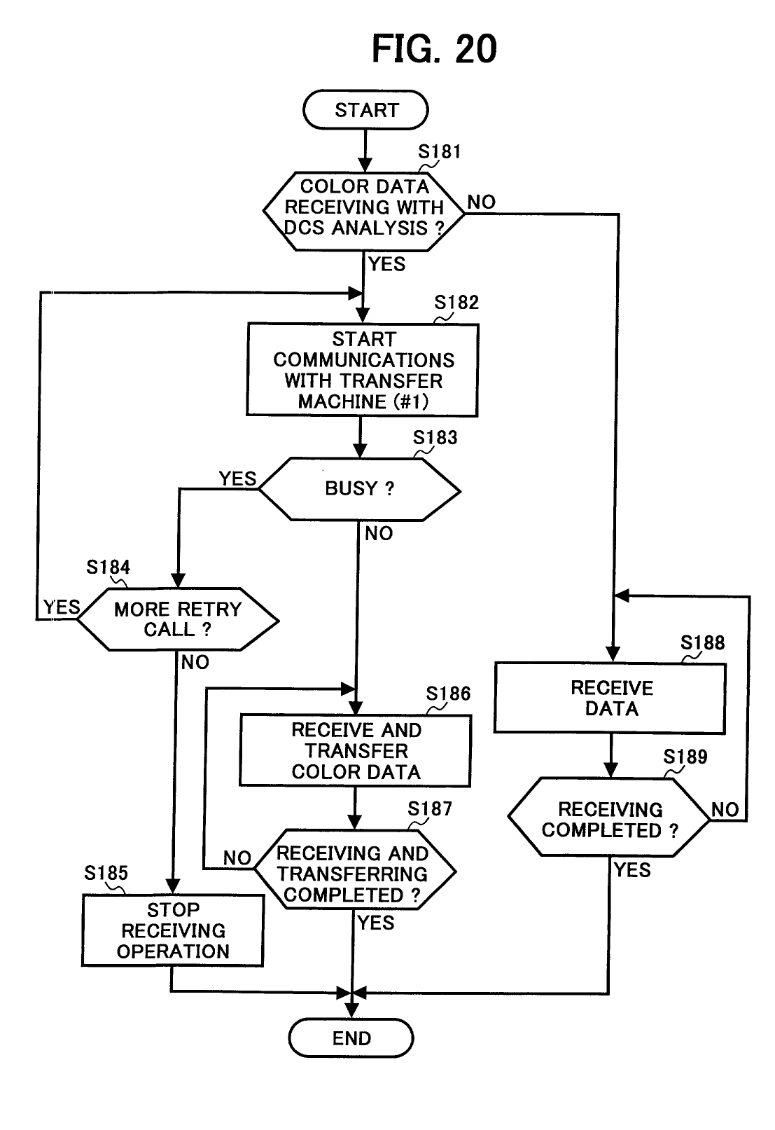

FIG. 20 shows another exemplary procedure of the DCS-analysis-based facsimile receiving operation performed by the facsimile apparatus 22. In this case, the facsimile apparatus 22 performs a predetermined number of retry calls to the registered color facsimile apparatus 11 for the color data transfer when the registered color facsimile apparatus 11 is detected as busy. For this purpose, the procedure of FIG. 20 is made by adding processes of Steps S193, s194, and S195 to the procedure of FIG. 16.

The facsimile apparatus 22 determines in Step S193 if the registered color facsimile apparatus 11 is busy after starting in Step S192 the communications with the registered color facsimile apparatus 11. If the registered color facsimile apparatus 11 is determined as busy, the system controller 207 further determines in Step S194 if the number of the retry calls made by that time does not reach the predetermined number. If the number of the retry calls made by that time is determined as reaching the predetermined number, the process proceeds to Step S195 in which the system controller 207 stops the facsimile receiving operation, and the process ends. If the number of the retry calls made by that time is determined as not reaching the predetermined number, the process returns to Step S195 to repeat the processes with an interval of a predetermined time period until the system controller 207 determines in Step S194 that the number of the retry calls made by that time is determined as reaching the predetermined number.

With the above structure, the facsimile apparatus 22 can perform a predetermined number of retry calls with an interval of a predetermined time period to a registered color facsimile apparatus for the color data transfer when the registered color facsimile apparatus is detected as busy.

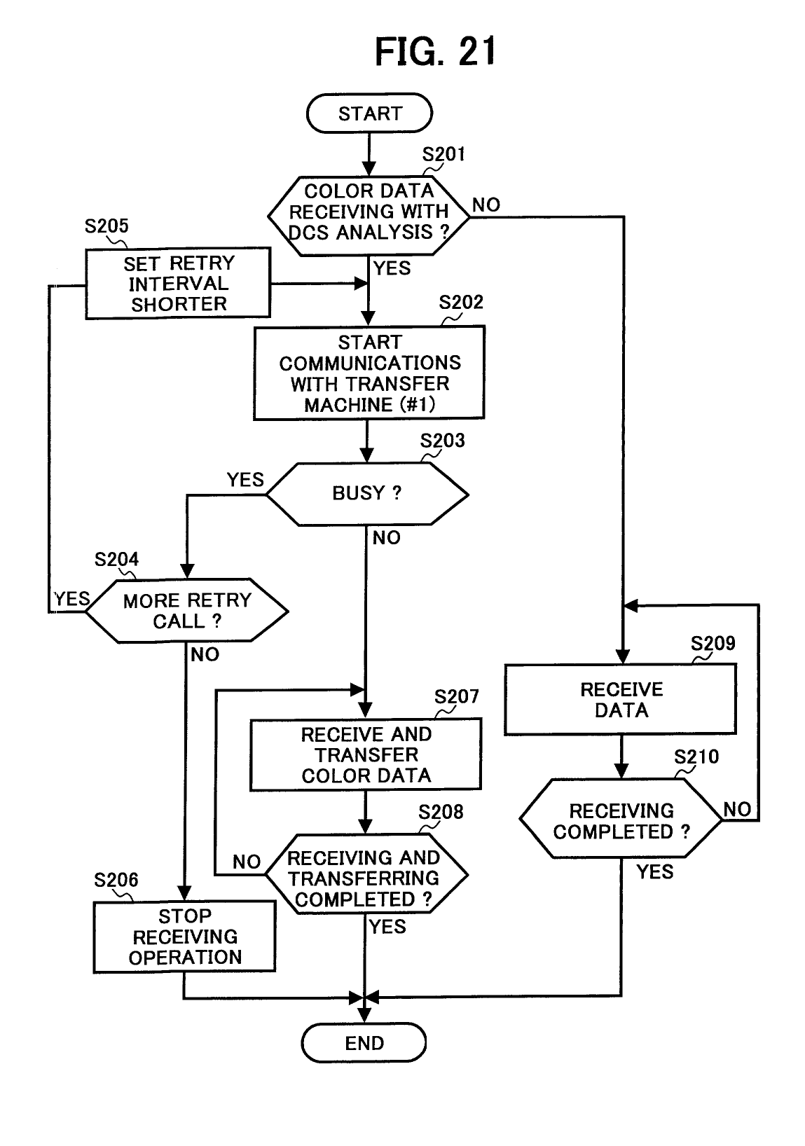

FIG. 21 shows another exemplary procedure of the DCS-analysis-based facsimile receiving operation performed by the facsimile apparatus 22. In this case, the facsimile apparatus 22 performs a predetermined number of retry calls with an interval of a relatively shorter time period to the registered color facsimile apparatus 11 for the color data transfer when the registered color facsimile apparatus 11 is detected as busy. For this purpose, the procedure of FIG. 21 is made by adding a process of Step S205 to the procedure of FIG. 20. That is, if the number of the retry calls made by that time is determined as not reaching the predetermined number, the process goes to Step S205 in which the time period for the interval to the next retry call is shortened and then returns to Step S202 so as to repeat the processes with an interval of a relatively shorter time period until the system controller 207 determines in Step S204 that the number of the retry calls made by that time is determined as reaching the predetermined number.

With the above structure, the facsimile apparatus 22 can perform a predetermined number of retry calls with an interval of a relatively shorter time period to a registered color facsimile apparatus for the color data transfer when the registered color facsimile apparatus is detected as busy. Thereby, the likelihood of succeeding the call initiation increases.

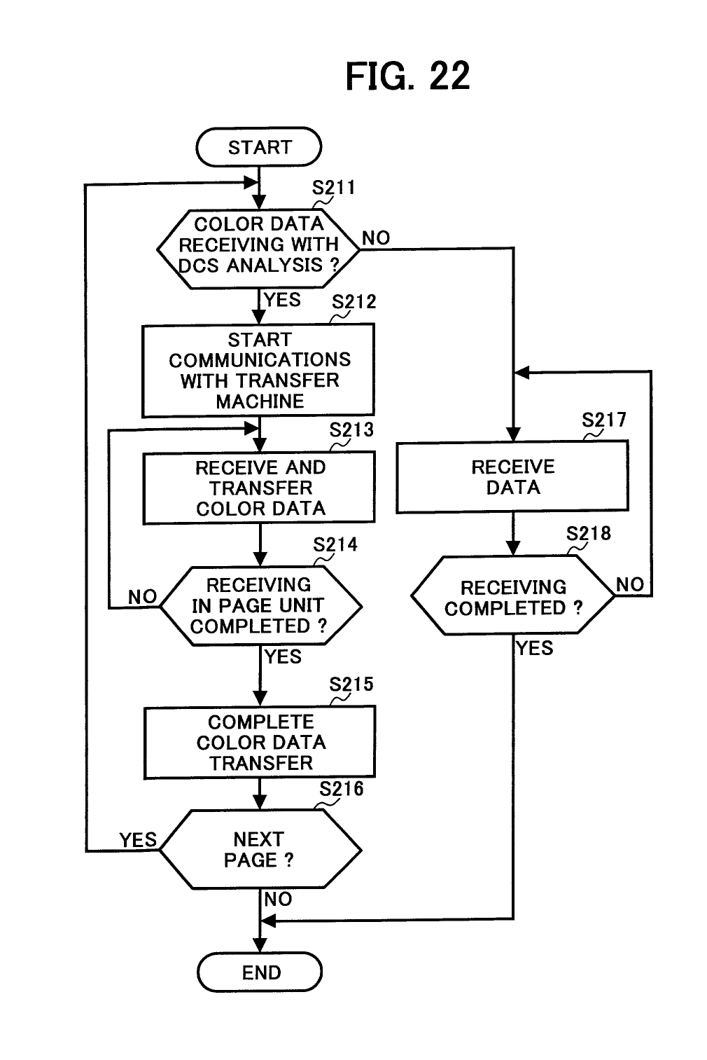

FIG. 22 shows another exemplary procedure of the DCS-analysis-based facsimile receiving operation performed by the facsimile apparatus 22. In this case, the facsimile apparatus 22 performs the color data transfer in page units to the registered color facsimile apparatus 11 for. For this purpose, the procedure of FIG. 22 is made by replacing the process of Step S164 in the procedure of FIG. 16 with processes of Steps S214-S216. That is, after the process of Step S213 where the receiving from the sending facsimile machine and the transmission to the transfer machine with respect to the color facsimile data are executed in parallel, the system controller 207 determines in Step S214 if the transfer operation in page units is completed. If the transfer operation in page units is determined as completed, the system controller 207 completes the transfer operation in page units, in Step S215. Then, in Step S216, the system controller 207 determines if the received facsimile information includes the following page. If the received facsimile information is determined as not including the following page, the process ends. But, if the received facsimile information is determined as including the following page, the process returns to Step S211 so that the system controller 207 can further determine if the following page includes color or mono-color gray-scale data and repeat the same processes.

With the above structure, the facsimile apparatus 22 can perform the color data transfer in page units to a registered color facsimile apparatus. Thereby, the facsimile apparatus 22 decreases a time for the color data transfer.

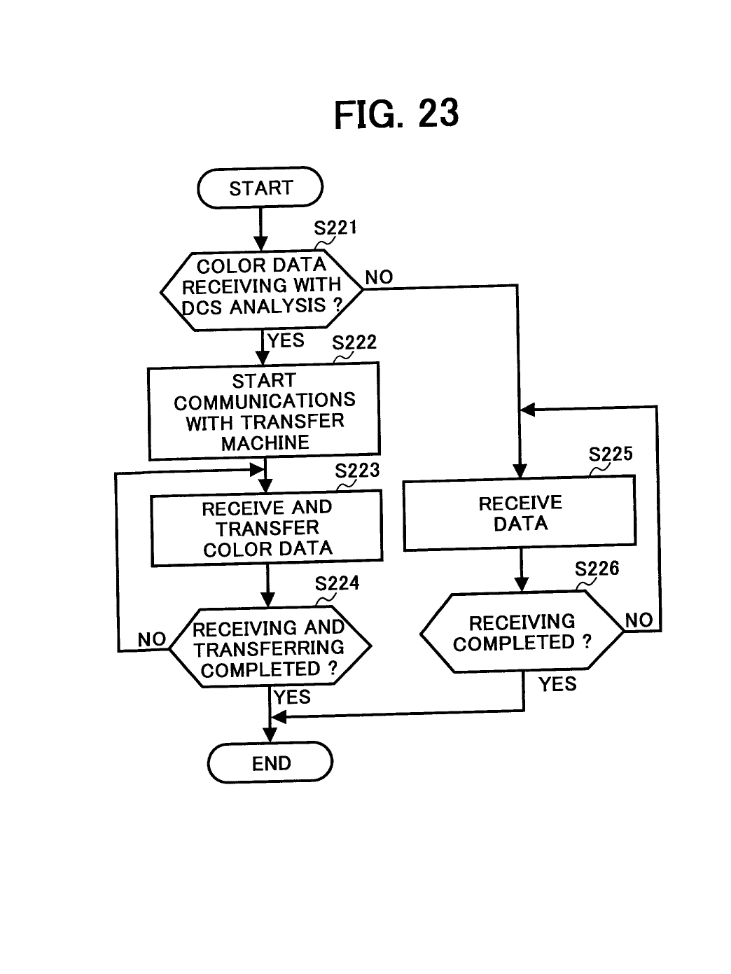

FIG. 23 shows another exemplary procedure of the DCS-analysis-based facsimile receiving operation performed by the facsimile apparatus 22. In this case, the facsimile apparatus 22 performs the color data transfer to the registered color facsimile apparatus 11 through the same type of the communications as is used in the receiving operation. For this purpose, the procedure of FIG. 23 is made by replacing the process of Step S162 in the procedure of FIG. 16 with a process of Step S222. That is, after the determination in Step S221 that the receiving facsimile information includes color or mono-color gray-scale data, the system controller 207 performs in Step S222 the transfer operation to the registered color facsimile apparatus 11 through the same type of the communications as is used in the receiving operation. After that, the process flows in the same manner as in the procedure of FIG. 16.

With the above structure, the facsimile apparatus 22 can perform the color data transfer to a registered color facsimile apparatus without changing the communications method. Thereby, the facsimile apparatus 22 can eliminate extra image processing operations required when the communications method is changed.

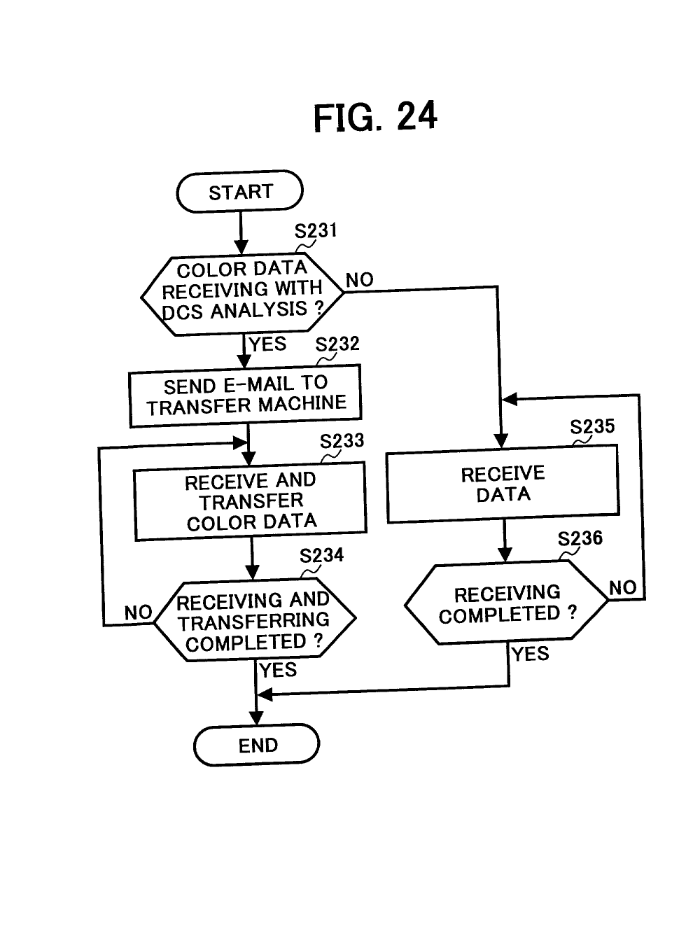

FIG. 24 shows another exemplary procedure of the DCS-analysis-based facsimile receiving operation performed by the facsimile apparatus 22. In this case, the facsimile apparatus 22 performs the color data transfer to the registered color facsimile apparatus 11 through E-mail. For this purpose, the procedure of FIG. 24 is made by replacing the process of Step S162 in the procedure of FIG. 16 with a process of Step S232. That is, after the determination in Step S231 that the receiving facsimile information includes color or mono-color gray-scale data, the system controller 207 performs in Step S232 the transfer operation to the registered color facsimile apparatus 11 through E-mail. After that, the process flows in the same manner as in the procedure of FIG. 16.

With the above structure, the facsimile apparatus 22 can perform the color data transfer to a registered color facsimile apparatus regardless of what receiving capabilities the facsimile apparatus 22 has.

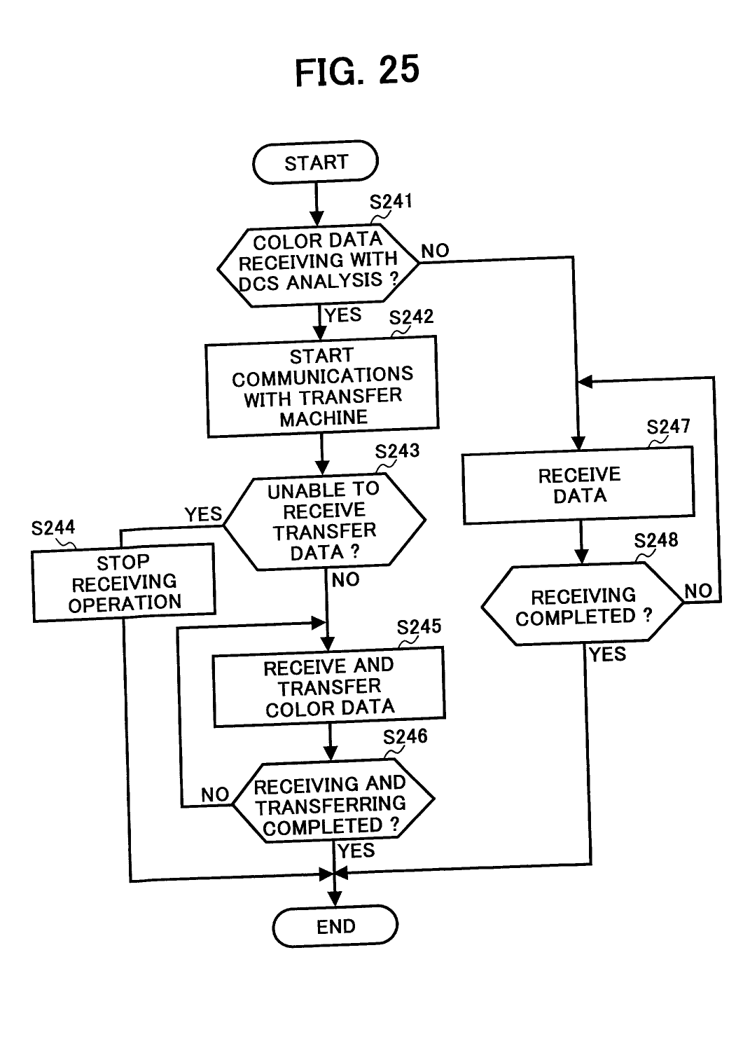

FIG. 25 shows another exemplary procedure of the DCS-analysis-based facsimile receiving operation performed by the facsimile apparatus 22. In this case, the facsimile apparatus 22 stops the receiving operation upon detecting that the transfer machine is unable to receive the transfer color data. Accordingly, the facsimile apparatus 22 afterwards sends an error signal back to the sending facsimile machine so that the sending facsimile machine can make sure that the facsimile reaches the facsimile apparatus 22. For this purpose, the procedure of FIG. 25 is made by adding processes of Steps S243 and S244 to the procedure of FIG. 16. That is, after starting in Step S242 the transfer operation to the registered color facsimile apparatus 11, the system controller 207 determines in Step S243 whether the registered color facsimile apparatus 11 is unable to receive the color transfer data sent from the facsimile apparatus 22. If the registered color facsimile apparatus 11 is determined as in the condition unable to receive the color transfer data, the process goes to Step S244. In Step S244, the system controller 207 stops the receiving operation. The process then ends. Other than that, the process flows in the same manner as in the procedure of FIG. 16.

With the above structure, the facsimile apparatus 22 can stop the receiving operation upon detecting that the transfer machine is in a condition unable to receive the transfer color data. Accordingly, the facsimile apparatus 22 is afterwards capable of sending an error signal back to the sending facsimile machine so that the sending facsimile machine can make sure that the facsimile reaches the facsimile apparatus 22. Thereby, the facsimile apparatus 22 increases reliability of the communications.

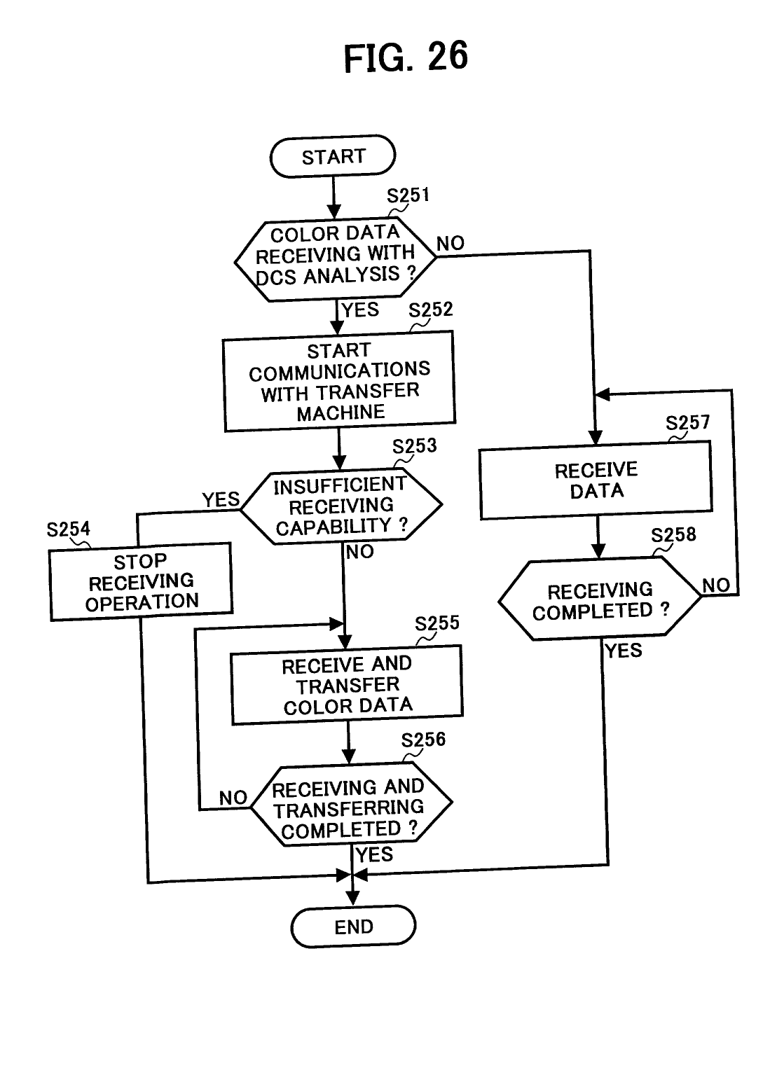

FIG. 26 shows another exemplary procedure of the DCS-analysis-based facsimile receiving operation performed by the facsimile apparatus 22. In this case, the facsimile apparatus 22 stops the receiving operation upon detecting hat the transfer machine reduces its receiving capability because of occurrence of paper out, toner out, etc. For this purpose, the procedure of FIG. 26 is made by adding processes of Steps S253 and S254 to the procedure of FIG. 16. That is, after starting in Step S252 the transfer operation to the registered color facsimile apparatus 11, the system controller 207 determines in Step S253 whether the registered color facsimile apparatus 11 has reduced its receiving capability to a level insufficient to continue to receive the color transfer data. If the registered color facsimile apparatus 11 is determined as having reduced receiving capability, the process goes to Step S254. In Step S254, the system controller 207 stops the receiving operation. The process then ends. Other than that, the process flows in the same manner as in the procedure of FIG. 16.

With the above structure, the facsimile apparatus 22 can stop the receiving operation upon detecting that the transfer machine has reduced its receiving capability because of occurrence of paper out, toner out, etc. Thereby, the facsimile apparatus 22 increases reliability of the communications.

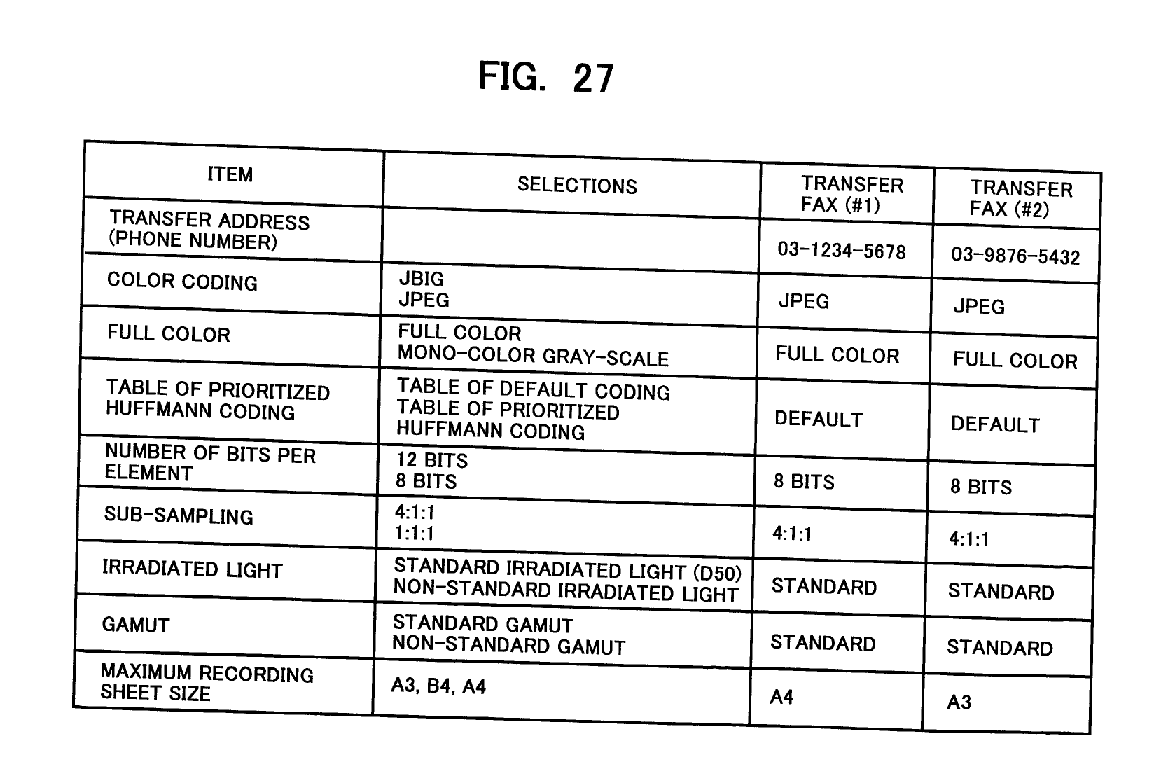

FIG. 27 shows another table of color image parameters relating to color stored in the image parameter memory 210 of the facsimile apparatus 22.

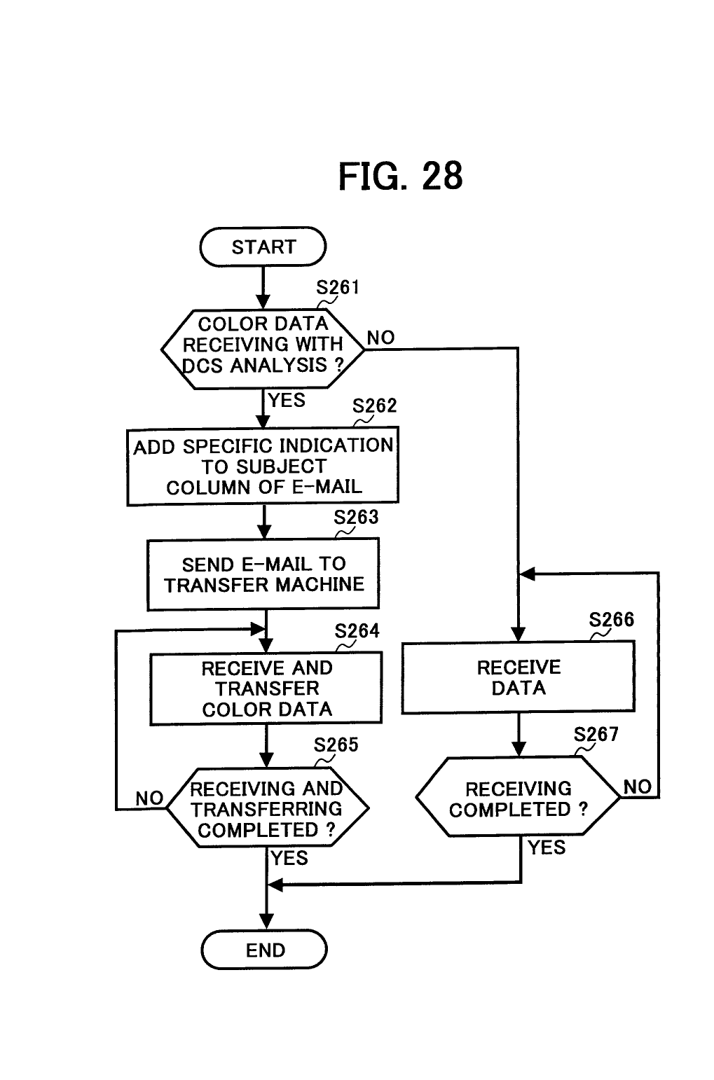

FIG. 28 shows another exemplary procedure of the DCS-analysis-based facsimile receiving operation performed by the facsimile apparatus 22. In this case, the facsimile apparatus 22 adds a specific literal indication in a subject column representing a subject of E-mail when transferring E-mail including the color transfer data to the registered color facsimile machine. Such specific literal indication may include a word, a phrase, a symbol, etc., such as “color facsimile transferred from the facsimile apparatus 22,” for example. For this purpose, the procedure of FIG. 28 is made by adding a process of Step S262 to the procedure of FIG. 24. That is, after determining in Step S261 that the receiving facsimile information includes color or mono-color gray-scale data, the system controller 207 performs the process of the literal indication adding to the subject column or line, in Step S262. After that, in Step S263, the system controller 207 starts transferring the received color facsimile information through E-mail to the registered color facsimile apparatus 11. The process then ends. Other than that, the process flows in the same manner as in the procedure of FIG. 24.

With the above structure, the facsimile apparatus 22 can add a specific literal indication to the E-mail so that the operator of the registered color facsimile apparatus 11 can easily understand that the received E-mail is a transferred color facsimile from the facsimile apparatus 22.

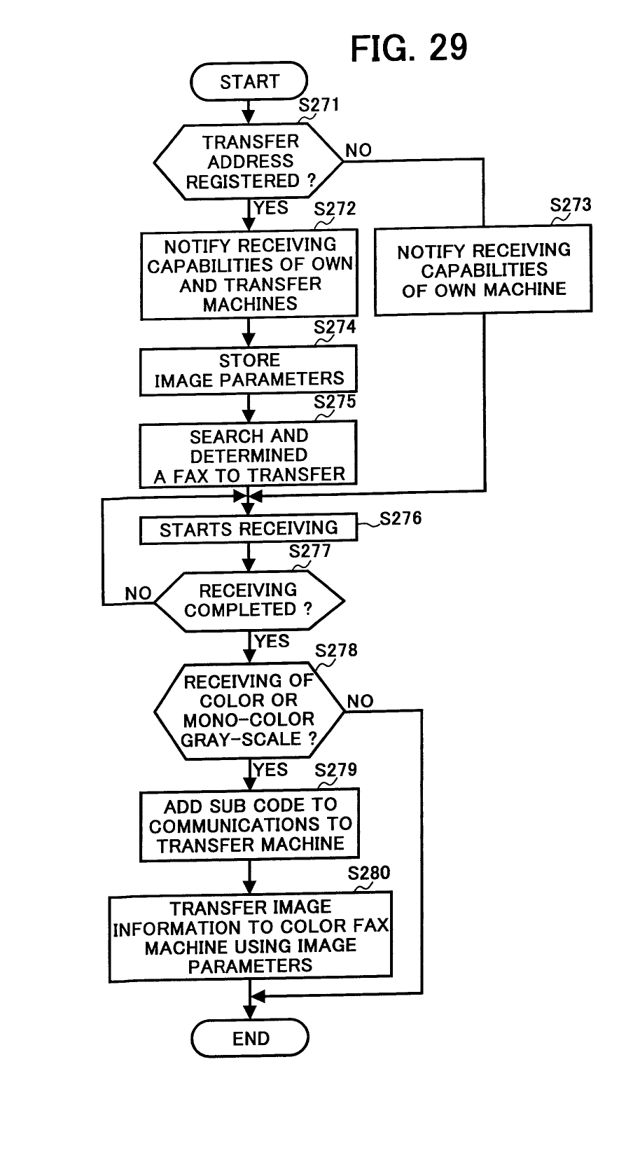

FIG. 29 shows another exemplary procedure of the DCS-analysis-based facsimile receiving operation performed by the facsimile apparatus 22. In this case, the facsimile apparatus 22 adds a SUB code to the communications for the color facsimile data transfer to identify that the facsimile is a color facsimile transferred from the facsimile apparatus 22 so that the registered color facsimile apparatus 11 can sort the transferred color facsimile information according to the received SUB code, for example, by outputting the transferred color facsimile information into a specific output tray. The SUB code is defined by the recommendations of ITU-T (International Telecommunication Union-Telecommunication) such that the SUB code includes a numerical number, a space, an asterisk symbol, and a sharp symbol in the total of 20 digits or less. For this purpose, the procedure of FIG. 29 is made by adding a process of Step S279 to the procedure of FIG. 8. That is, after determining in Step S278 that the receiving facsimile information includes color or mono-color gray-scale data, the system controller 207 adds in Step S279 an arbitrary determined SUB code to the communications with the registered color facsimile apparatus 11. After that, in Step S280, the system controller 207 starts transferring the received color facsimile information to the registered color facsimile apparatus 11. The process then ends. Other than that, the process flows in the same manner as in the procedure of FIG. 8.

With the above structure, the facsimile apparatus 22 can add an arbitrary determined SUB code to the communications with the registered color facsimile apparatus 11 so that the registered color facsimile apparatus 11 can sort the transferred color facsimile information from the facsimile apparatus 22.

The above examples mainly relate to the capability of color facsimile, however, the techniques of the present application can also be applied to other capabilities such as facsimile requiring a large sized recording sheet (e.g., an A3-sized sheet), for example.

This invention may be conveniently implemented using a conventional general purpose digital computer programmed according to the teaching of the present specification, as will be apparent to those skilled in the computer art. Appropriate software coding can readily be prepared by skilled programmers based on the teachings of the present disclosure, as will be apparent to those skilled in the software art. The present invention may also be implemented by the preparation of application specific integrated circuits or by interconnecting an appropriate network of conventional component circuits, as will be readily apparent to those skilled in the art.

Numerous additional modifications and variations of the present application are possible in light of the above teachings. It is therefore to be understood that within the scope of the appended claims, the present application may be practiced otherwise than as specifically described herein.

This application claims priority to Japanese patent application p This. JPAP2000-178911 filed on Jun. 14, 2000 and JPAP2001-85353 filed on Mar. 23, 2001 in the Japanese Patent Office, the entire contents of which are hereby incorporated by reference.

What is claimed:

1. A communications terminal apparatus, comprising:
a communications mechanism configured to perform communications with a plurality of communications machines including a sending communications machine and a transfer communications machine;
a registering mechanism configured to register an address and a communications capability of said transfer communications machine;
a notifying mechanism configured to notify of said communications capability of said transfer communications machine registered in said registering mechanism; and
a controlling mechanism configured to instruct said notifying mechanism to notify said sending communications machine of said communications capability at a beginning of communications and to instruct said communications mechanism to transfer image information received from said sending communications machine to said transfer communications machine using said address stored in said registering mechanism.

2. A communications terminal apparatus, comprising:
a communications mechanism configured to perform communications with a plurality of communications machines including a sending communications machine and a transfer communications machine;
a registering mechanism configured to register an address and a communications capability of said transfer communications machine;
a memory storing a set of image parameters;
a notifying mechanism configured to notify of an enhancement communications capability of said apparatus in accordance with said communications capability of said transfer communications machine; and
a controlling mechanism configured to instruct said notifying mechanism to notify said sending communications machine of said enhancement communications capability at a beginning of communications and to instruct said communications mechanism to transfer image information received from said sending communications machine to said transfer communications machine using said address and said set of image parameters stored in said memory.

3. An apparatus as defined in claim 2, wherein said image information includes color and/or mono-color gray-scale data.

4. An apparatus as defined in claim 3, further comprising an enabling mechanism for enabling a color image receiving function when said address and said communications capability of said transfer communications machine are registered in said registering mechanism.

5. An apparatus as defined in claim 2, wherein said controlling mechanism is configured to instruct said communications mechanism to communicate with said transfer communications machine to obtain said communications capability of said transfer communications machine when said communications capability of said transfer communications machine is registered in said registering mechanism.

6. An apparatus as defined in claim 2, further comprising another communications mechanism configured to perform communications with a plurality of communications machines including a sending communications machine and a transfer communications machine,
wherein said apparatus separately uses said communications mechanisms for receiving and transferring, and
wherein said controlling mechanism changes communications protocols for a transferring operation and accordingly converts said image parameters stored in said memory.

7. An apparatus as defined in claim 6, wherein said controlling mechanism is configured to start to transfer said image information received from said sending communications machine to said transfer communications machine before a completion of receiving said image information from said sending communications machine.

8. An apparatus as defined in claim 7, wherein said controlling mechanism is configured to obtain a latest communications capability through said communications mechanism when transferring said image information and to update said registration mechanism with said latest communications capability.

9. An apparatus as defined in claim 7, wherein said controlling mechanism is configured to obtain a latest communications capability through said communications mechanism at intervals of a predetermined time period and to update said registration mechanism with said latest communications capability.

10. An apparatus as defined in claim 7, wherein said controlling mechanism is configured to detect at the beginning of said communications that said image information is sent and to conduct a call initiation to said transfer communications machine when detecting that said image information is sent.

11. An apparatus as defined in claim 7, wherein said controlling mechanism is configured to detect that said transfer communications machine is busy and to then stop receiving said image information from said sending communications machine.

12. An apparatus as defined in claim 7, wherein said controlling mechanism is configured to transfer said image information to another registered transfer communications machine upon a detection of an event indicating that said transfer communications machine is busy.

13. An apparatus as defined in claim 7, wherein said controlling mechanism is configured to perform a retry call to said transfer communications machine upon a detection of an event indicating that said transfer communications machine is busy.

14. An apparatus as defined in claim 7, wherein said controlling mechanism is configured to perform a retry call at intervals of a predetermined time period to said transfer communications machine upon a detection of an event indicating that said transfer communications machine is busy.

15. An apparatus as defined in claim 7, wherein said controlling mechanism is configured to transfer said image information in page units.

16. An apparatus as defined in claim 7, wherein said controlling mechanism is configured to transfer said image information using a type of communications same as that used to receive said image information with said communications mechanism.

17. An apparatus as defined in claim 7, wherein said controlling mechanism is configured to transfer said image information through E-mail to said transfer communications machine.

18. An apparatus as defined in claim 7, wherein said controlling mechanism is configured to detect that said transfer communications machine is incapable of receiving said image information and to then stop receiving said image information from said sending communications machine.

19. An apparatus as defined in claim 8, wherein said controlling mechanism is configured to determine whether said latest communications capability is sufficient to receive said image information and stops receiving said image information from said sending communications machine when said latest communications capability is determined as not sufficient to receive said image information.

20. An apparatus as defined in claim 17, wherein said controlling mechanism is configured to add a literal identification of said image information to said E-mail.

21. An apparatus as defined in claim 7, wherein said controlling mechanism is configured to transfer said image information with a predetermined identification code causing said transfer communications machine to reproduce an output of said image information into a predetermined recording sheet tray corresponding to said predetermined identification code.

22. An apparatus as defined in claim 7, wherein said controlling mechanism is configured to determine whether an own communications capability can accept said image information and to transfer said image information to said transfer communications machine when said own communications capability of said apparatus cannot accept said image information.

23. A communications terminal apparatus, comprising:
communicating means for performing communications with a plurality of communications machines including a sending communications machine and a transfer communications machine;
registering means for registering an address and a communications capability of said transfer communications machine;
notifying means for notifying of said communications capability of said transfer communications machine registered in said registering means; and
controlling means for instructing said notifying means to notify said sending communications machine of said communications capability at a beginning of communications and instructing said communications means to transfer image information received from said sending communications machine to said transfer communications machine using said address stored in said registering means.

24. A communications terminal apparatus, comprising:
communicating means for performing communications with a plurality of communications machines including a sending communications machine and a transfer communications machine;
registering means for registering an address and a communications capability of said transfer communications machine;
storing means for storing and a set of image parameters;
notifying means for notifying of an enhancement communications capability of said apparatus in accordance with said communications capability of said transfer communications machine; and
controlling means for instructing said notifying means to notify said sending communications machine of said enhancement communications capability at a beginning of communications and instructing said communications means to transfer image information received from said sending communications machine to said transfer communications machine using said address and said set of image parameters stored in said storing means.

25. An apparatus as defined in claim 24, wherein said image information includes color or mono-color gray-scale data.

26. An apparatus as defined in claim 25, further comprising enabling means for enabling a color image receiving function when said address and said communications capability of said transfer communications machine are registered in said registering means.

27. An apparatus as defined in claim 24, wherein said controlling means comprises means to instruct said communications means to communicate with said transfer communications machine to obtain said communications capability of said transfer communications machine when said communications capability of said transfer communications machine is registered in said registering means.

28. An apparatus as defined in claim 24, further comprising another communications means configured to perform communications with a plurality of communications machines including a sending communications machine and a transfer communications machine,
wherein said apparatus separately uses said communications means for receiving and transferring, and
wherein said controlling means changes communications protocols for a transferring operation and accordingly converts said image parameters stored in said storing means.

29. An apparatus as defined in claim 28, wherein said controlling means includes means to start to transfer said image information received from said sending communications machine to said transfer communications machine before a completion of receiving said image information from said sending communications machine.

30. An apparatus as defined in claim 29, wherein said controlling means includes means to obtain a latest communications capability through said communications means when transferring said image information and to update said registration means with said latest communications capability.

31. An apparatus as defined in claim 29, wherein said controlling means includes means to obtain a latest communications capability through said communications means at intervals of a predetermined time period and to update said registration means with said latest communications capability.

32. An apparatus as defined in claim 29, wherein said controlling means includes means to detect at the beginning of said communications that said image information is sent and to conduct a call initiation to said transfer communications machine when detecting that said image information is sent.

33. An apparatus as defined in claim 29, wherein said controlling means includes means to detect that said transfer communications machine is busy and to then stop receiving said image information from said sending communications machine.

34. An apparatus as defined in claim 29, wherein said controlling means includes means to transfer said image information to another registered transfer communications machine upon a detection of an event indicating that said transfer communications machine is busy.

35. An apparatus as defined in claim 29, wherein said controlling means includes means to perform a retry call to said transfer communications machine upon a detection of an event indicating that said transfer communications machine is busy.

36. An apparatus as defined in claim 29, wherein said controlling means includes means to perform a retry call at intervals of a predetermined time period to said transfer communications machine upon a detection of an event indicating that said transfer communications machine is busy.

37. An apparatus as defined in claim 29, wherein said controlling means includes means to transfer said image information in page units.

38. An apparatus as defined in claim 29, wherein said controlling means includes means to transfer said image information using a type of communications same as that used to receive said image information with said communications means.

39. An apparatus as defined in claim 29, wherein said controlling means includes means to transfer said image information through E-mail to said transfer communications machine.

40. An apparatus as defined in claim 29, wherein said controlling means includes means to detect that said transfer communications machine is incapable of receiving said image information and to then stop receiving said image information from said sending communications machine.

41. An apparatus as defined in claim 30, wherein said controlling means includes means to determine whether said latest communications capability is sufficient to receive said image information and to stop receiving said image information from said sending communications machine when said latest communications capability is determined as not sufficient to receive said image information.

42. An apparatus as defined in claim 39, wherein said controlling means includes means to add a literal identification of said image information to said E-mail.

43. An apparatus as defined in claim 29, wherein said controlling means includes means to transfer said image information with a predetermined identification code to cause said transfer communications machine to reproduce an output of said image information into a predetermined recording sheet tray corresponding to said predetermined identification code.

44. An apparatus as defined in claim 29, wherein said controlling means includes means to determine whether an own communications capability can accept said image information and to transfer said image information to said transfer communications machine when said own communications capability of said apparatus cannot accept said image information.

45. A method of transferring image information, comprising the steps of:
registering an address and a communications capability of a transfer communications machine;
notifying a sending communications machine of said communications capability of said transfer communications machine at a beginning of communications;
receiving image information from said sending communications machine; and
transferring said image information received from said sending communications machine to said transfer communications machine using said address of said transfer communications machine.

46. A method of transferring image information, comprising the steps of:
registering an address and a communications capability of a transfer communications machine;
storing a set of image parameters;
notifying of an enhancement communications capability in accordance with said communications capability of said transfer communications machine at a beginning of communications;
receiving image information from a sending communications machine; and
transferring said image information received from said sending communications machine to said transfer communications machine using said address and said set of image parameters stored in said storing step.

47. A method as defined in claim 46, wherein said image information includes color or mono-color gray-scale data.

48. A method as defined in claim 47, further comprising a step of enabling for enabling a color image receiving function when said registering step registers said address and said communications capability of said transfer communications machine.

49. A method as defined in claim 46, further comprising a step of communicating for communicating with said transfer communications machine to obtain said communications capability of said transfer communications machine when said registering step registers said communications capability of said transfer communications machine.

50. A method as defined in claim 46, wherein said transferring step uses a communications line and communications protocols different from those used for said receiving step with different image parameters converted from said image parameters stored in said storing step.

51. A method as defined in claim 50, wherein said transferring step starts to transfer said image information before a completion of receiving said image information from said sending communications machine.

52. A method as defined in claim 51, wherein said transferring step obtains a latest communications capability from said transfer communications machine when transferring said image information and updates said latest communications capability registered in said registering step.

53. A method as defined in claim 51, wherein said transferring step obtains a latest communications capability from said transfer communications machine at intervals of a predetermined time period and updates said latest communications capability registered in said registering step.

54. A method as defined in claim 51, further comprising a step of detecting for detecting at the beginning of said communications that said image information is sent, and wherein said transferring step sends a call initiation to said transfer communications machine when said detecting step detects that said image information is sent.

55. A method as defined in claim 51, further comprising a detecting step for detecting that said transfer communications machine is busy, and wherein said receiving step stops receiving when said detecting step detects that said transfer communications machine is busy.

56. A method as defined in claim 51, wherein said transferring step transfers said image information to another registered transfer communications machine upon a detection of an event indicating that said transfer communications machine is busy.

57. A method as defined in claim 51, wherein said transferring step performs a retry call to said transfer communications machine upon a detection of an event indicating that said transfer communications machine is busy.

58. A method as defined in claim 51, wherein said transferring step performs a retry call at intervals of a predetermined time period to said transfer communications machine upon a detection of an event indicating that said transfer communications machine is busy.

59. A method as defined in claim 51, wherein said transferring step transfers said image information in page units.

60. A method as defined in claim 51, wherein said transferring step transfers said image information using a type of communications same as that used by said receiving step.

61. A method as defined in claim 51, wherein said transferring step transfers said image information through E-mail to said transfer communications machine.

62. A method as defined in claim 51, further comprising a detecting step for detecting that said transfer communications machine is incapable of receiving said image information, and wherein said receiving step stops receiving when said detecting step detects that said transfer communications machine is incapable of receiving said image information.

63. A method as defined in claim 52, further comprising a determining step for determining whether said latest communications capability is sufficient to receive said image information, and wherein said receiving step stops receiving when said determining step determines said latest communications capability is not sufficient to receive said image information.

64. A method as defined in claim 61, further comprising an adding step for adding a literal identification of said image information to said E-mail.

65. A method as defined in claim 51, wherein said transferring step transfers said image information with a predetermined identification code to cause said transfer communications machine to reproduce an output of said image information into a predetermined recording sheet tray corresponding to said predetermined identification code.

66. A method as defined in claim 51, further comprising a determining step for determining whether an own communications capability can accept said image information, and wherein said transferring step transfers said image information to said transfer communications machine when said determining step determines that said own communications capability of said apparatus cannot accept said image information.

67. A method comprising:
receiving a fax transmission at a receiving fax machine checking through an automated process if the fax transmission contains color image information; and
if said checking determines that the fax transmission contains color image information, transferring at least the color image information, though an automated process, from the receiving fax machine to a transfer fax machine that has color printing capabilities for printing of said color image information.

68. A method as in claim 67 in which said transferring is by fax transmission from the receiving fax machine to the transfer fax machine.

69. A method as in claim 67 in which said transferring is by e-mail transmission.

70. A method as in claim 67 in which said checking comprises analyzing an initial portion of the fax transmission to see if a subsequent portion of the fax transmission contains color image information.

71. A method as in claim 67 in which said transferring includes generating contact information identifying said transfer fax machine on the basis of information stored at said receiving fax machine before said fax transmission.

72. A method as in claim 71 in which said generating of contact information includes selecting said transfer fax machine from a plurality of fax machines for which contact information has been stored at the receiving fax machine.

73. A method as in claim 67 including concurrently receiving said fax transmission at the receiving fax machine and transferring said fax transmission from the receiving to the transfer fax machine.

74. A method as in claim 67 including storing, at said receiving fax machine, contact information regarding one or more transfer fax machines that have color printing capabilities and updating said contact information from time to time through an automated process.

75. A method as in claim 74 in which said contact information comprises information regarding color information processing capabilities of said one or more transfer fax machines.

76. A method as in claim 74 in which said transferring includes selecting through an automated process one of several transfer fax machines for which contact information is stored in the receiving fax machine, determining if the so selected transfer fax machine is available and, if it not, selecting another, available transfer machine from among those for which contact information is stored at the receiving fax machine.

77. A method as in claim 76 in which the stored contact information includes information regarding color information handling capabilities or said one or more transfer fax machines and said selecting includes taking into account, through automated process, a relationship between said fax transmission and said color information processing capabilities.

78. A method as in claim 67 in which said transferring includes adding, by the receiving fax machine, a subject line to the transferred fax transmission.

79. A method as in claim 67 in which said transferring includes adding, by the receiving fax machine, a code to the transferred fax transmission designating a manner of handling prints of the transferred fax transmission at the transfer fax machine.

80. A method as in claim 67 in which said checking comprises checking if the fax transmission includes color information on a page-by-page basis and said transferring comprises transferring to the transfer fax machine only pages of said fax transmission that contain color information.
